(19) United States
(12) Patent Application Publication
(10) Pub. No.: US 2022/0218033 A1
(43) Pub. Date: Jul. 14, 2022

(54) AEROSOL PROVISION DEVICE

(71) Applicant: NICOVENTURES TRADING LIMITED, London (GB)

(72) Inventors: Gary FALLON, London (GB); Luke WARREN, London (GB); Adam ROACH, London (GB); Zoltan HERCZ, London (GB); Srikanth NAULE, London (GB); Thomas WESTON, London (GB); Mitchel THORSEN, Madison, WI (US); Jack QUARMBY, London Greater London (GB); Charles Leoni, London Greater London (GB); David RUSHFORTH, London (GB); Timothy BARKER, London (GB)

(21) Appl. No.: 17/596,296

(22) PCT Filed: Jun. 5, 2020
(86) PCT No.: PCT/EP2020/065744

§ 371 Date: Dec. 7, 2021

Related U.S. Application Data
(60) Provisional application No. 62/938,058, filed on Nov. 20, 2019.

(30) Foreign Application Priority Data
Jun. 8, 2019 (GB) 1908204.9
Jul. 26, 2019 (GB) 1910758.0

(51) Int. Cl. A24F 40/465; A24F 40/20; A24F 40/51; A24F 40/57; H05B 6/10

(52) U.S. Cl. CPC A24F 40/465; A24F 40/20; H05B 6/105; A24F 40/57; A24F 40/51

(57) ABSTRACT

Disclosed are various aerosol provision devices that may inhibit or prevent the accumulation of condensation, during use, in a conduit that connects the device's heating chamber to the device's exterior. In devices according to one aspect, the interior surface of such a conduit is heated during a session of use. In devices according to another aspect, the interior surface of such a conduit is heated, such that at least a portion of its interior surface attains a temperature greater than or equal to 85° C. In devices according to another aspect, a portion of the interior surface of such a conduit has a thermal conductivity greater than or equal to 1 W/m/K. In another aspect, the interior surface of such a conduit is heated such that at least a middle portion of the interior surface attains a temperature greater than or equal to 70° C. Devices according to a further aspect include an air heating unit for heating air within such a conduit to thereby substantially prevent accumulation of condensation within the conduit. In devices according to a still further aspect, at least a portion of such a conduit is defined by a component comprising a first susceptor, with the first susceptor being heatable by an inductor that forms part of a heating assembly for heating the device's heating chamber; the susceptor in turn heats the conduit, thereby substantially preventing accumulation of condensation within the conduit. In devices according to yet another aspect, at least a portion of such a conduit is defined by a component comprising thermally conductive material, with the thermally conductive material of the component abutting a heating element that forms part of a heating assembly for heating the device's heating chamber, so that the component is heatable by thermal conduction from the heating element, thereby substantially preventing accumulation of condensation within the conduit. Devices according to a still further aspect, when an article comprising aerosol-generating material is fully inserted in the device and is engaged with a stop within the device, there is a first portion of a length of the article that does not overlap with any heating element, the first portion extending either proximally from the distal end of the article, distally from a proximal end of the article. In devices according to another aspect, one or more components define such a conduit and a heating chamber for the device, the one or more components providing a hermetic seal where the heating chamber and the conduit meet.

### TECHNICAL FIELD

The present invention relates to an aerosol provision device, a method of generating an aerosol using the aerosol provision device, and an aerosol-generating system comprising the aerosol provision device.

### BACKGROUND

Articles such as cigarettes, cigars and the like burn tobacco during use to create tobacco smoke. Attempts have been made to provide alternatives to these types of articles, which burn tobacco, by creating products that release compounds without burning. Apparatus is known that heats smokable material to volatilise at least one component of the smokable material, typically to form an aerosol which can be inhaled, without burning or combusting the smokable material. Such apparatus is sometimes described as a “heat-not-burn” apparatus or a “tobacco heating product” (THP) or “tobacco heating device” or similar. Various different arrangements for volatilising at least one component of the smokable material are known.

The material may be for example tobacco or other non-tobacco products or a combination, such as a blended mix, which may or may not contain nicotine.

### SUMMARY OF INVENTION

According to a first aspect of the present invention, there is provided an aerosol provision device comprising: a heating chamber for receiving the aerosol-generating material; an inductive heating unit for heating the aerosol-generating material during a session of use; and a conduit having an interior surface, the conduit fluidically connecting the heating chamber with the exterior of the aerosol provision device; wherein the aerosol provision device is configured so that the interior surface of the conduit is heated during a session of use to thereby substantially prevent accumulation of condensation within the conduit.

According to a further aspect of the present invention, there is provided an aerosol provision device for generating aerosol from aerosol-generating material, the aerosol provision device comprising: a heating chamber for receiving the aerosol-generating material; an inductive heating unit for heating the aerosol-generating material during a session of use, when the aerosol-generating material is located in the heating chamber; and a conduit having an interior surface, the conduit fluidically connecting the heating chamber with the exterior of the aerosol provision device; wherein the aerosol provision device is configured so the interior surface of the conduit is heated during the session of use, so that at least a portion of the interior surface attains a temperature greater than or equal to 85° C.

According to a still further aspect of the present invention there is provided an aerosol provision device for generating aerosol from aerosol-generating material, the aerosol provision device comprising: a heating chamber for receiving the aerosol-generating material; a heating unit for heating the aerosol-generating material during a session of use; and a conduit having an interior surface, the conduit fluidically connecting the heating chamber with the exterior of the aerosol provision device; wherein at least a portion of the interior surface has a thermal conductivity greater than or equal to 1 W/m/K.

According to a still further aspect of the present invention there is provided an aerosol provision device for generating aerosol from aerosol-generating material, the aerosol provision device comprising: a heating chamber for receiving the aerosol-generating material; a heating unit for heating the aerosol-generating material during a session of use; and a conduit having an interior surface, the conduit fluidically connecting the heating chamber with the exterior of the aerosol provision device; wherein the aerosol provision device is configured so the interior surface of the conduit is heated during the session of use and thereby at least a middle portion of the interior surface, which is mid-way between the proximal and distal ends of the conduit, attains a temperature greater than or equal to 70° C.

According to another aspect of the present invention there is provided an aerosol provision device for generating aerosol from aerosol-generating material, the aerosol provision device comprising: a heating chamber for receiving the aerosol-generating material; a heating unit for heating the aerosol-generating material during a session of use; a conduit fluidically connecting the heating chamber with the exterior of the aerosol provision device; and an air heating unit for heating air within the conduit to thereby substantially prevent accumulation of condensation within the conduit.

According to yet a further aspect of the present invention there is provided an aerosol provision device for generating aerosol from aerosol-generating material, the aerosol provision device comprising: a heating assembly comprising an inductor; a heating chamber for receiving the aerosol-generating material and within which the aerosol-generating material is heatable by the heating assembly; and a conduit fluidically connecting the heating chamber with an opening at an exterior of the aerosol provision device, wherein at least a portion of the conduit is defined by a component comprising a first susceptor; wherein the device is configured such that the first susceptor is heatable by the inductor to heat the conduit, thereby to substantially prevent accumulation of condensation within the conduit.

According to a still further aspect of the present invention there is provided an aerosol provision device for generating aerosol from aerosol-generating material, the aerosol provision device comprising: a heating assembly comprising a heating element that is heatable by the heating assembly; a heating chamber for receiving the aerosol-generating material and within which the aerosol-generating material is heatable by the heating element; and a conduit fluidically connecting the heating chamber with an opening at an exterior of the aerosol provision device, wherein at least a portion of the conduit is defined by a component comprising thermally conductive material; wherein the thermally conductive material of the component abuts the heating element so as to be heatable by thermal conduction from the heating element to heat the conduit, thereby to substantially prevent accumulation of condensation within the conduit.

According to yet another aspect of the present invention there is provided an aerosol provision device for receiving an article comprising aerosol-generating material and for generating aerosol from the aerosol-generating material, the aerosol provision device comprising: a stop, which prevents a distal end of the article from moving distally beyond a limit position when the article is inserted in the aerosol provision device; and a heating assembly for heating the aerosol-generating material during a session of use, the heating assembly comprising a heating element, within which heat is generated during use of the heating assembly; wherein, when the article is fully inserted into the device with the distal end of the article located at the limit position, there is a first portion of a length of the article that does not overlap with any heating element that is heatable to heat the article, the first portion extending either a first distance proximally from the distal end of the article, or a first distance distally from a proximal end of the article.

According to yet another aspect of the present invention there is provided an aerosol provision device for generating aerosol from aerosol-generating material, the aerosol provision device comprising: a heating assembly; and one or more components that define: a heating chamber for receiving the aerosol-generating material and within which the aerosol-generating material is heatable by the heating assembly; and a conduit fluidically connecting the heating chamber with an exterior of the aerosol provision device; wherein the one or more components provide a hermetic seal where the heating chamber and the conduit meet.

### BRIEF DESCRIPTION OF THE DRAWINGS

FIG. 1 shows a front view of an example of an aerosol provision device;

FIG. 2 shows an enlarged cross-sectional view of a heating assembly within an aerosol provision device;

FIG. 3a is close-up view of a cross-section through a modified version of the device of FIGS. 1 and 2, which includes a layer of thermally conductive material on the interior surface of the inlet conduit;

FIG. 3b is a close-up view of a cross-section through an alternative modified version of the device of FIGS. 1 and 2;

FIG. 3c is a close-up view of a cross-section through a further modified version of the device of FIGS. 1 and 2;

FIG. 3d is a close-up view of a cross-section through a still further modified version of the device of FIGS. 1 and 2;

FIG. 4 is close-up view of a cross-section through a modified version of the device of FIGS. 1 and 2, which includes an air heating unit for heating air within the inlet conduit of the device;

FIG. 5a is close-up view of a cross-section through a modified version of the device of FIGS. 1 and 2, which includes an inductively heated component defining the inlet conduit;

FIG. 5b is a schematic view of an alternative modified version of the device of FIGS. 1 and 2, which includes respective inductively heated components defining the inlet and outlet conduits;

FIG. 6a is a schematic view of another modified version of the device of FIGS. 1 and 2, in which components defining the conduits and heating chamber are sealingly joined to one another;

FIG. 6b is a schematic view of a modified version of the device of FIG. 6a, in which respective inductors are provided for causing the heating of the components defining the inlet conduit, the outlet conduit and the heating chamber;

FIG. 6c is a schematic view of yet another modified version of the device of FIGS. 1 and 2, in which a unitary component defines the inlet and outlet conduits and heating chamber;

FIG. 6d is a schematic view of a modified version of the device of FIG. 6c, in which respective inductors are provided for causing the heating of the components defining the inlet conduit, the outlet conduit and the heating chamber;

FIG. 7a is close-up view of a cross-section through a modified version of the device of FIGS. 1 and 2, which is configured such that a distal end portion of the aerosol-generating material in an inserted article is unheated;

FIG. 7b is schematic view of an alternative modified version of the device of FIGS. 1 and 2, which is configured such that proximal and distal end portions of the aerosol-generating material in an inserted article are unheated;

FIG. 8 shows a front view of the aerosol provision device of FIG. 1 with an outer cover removed;

FIG. 9 shows a cross-sectional view of the aerosol provision device of FIG. 1;

FIG. 10 shows an exploded view of the aerosol provision device of FIG. 1;

FIG. 11A shows a cross-sectional view of a heating assembly within an aerosol provision device; and

FIG. 11B shows a close-up view of a portion of the heating assembly of FIG. 11A.

### DETAILED DESCRIPTION

To facilitate formation of an aerosol in use, aerosol-generating material for aerosol provision devices (e.g. tobacco heating products) usually contains more water and/or aerosol-generating agent than the smokeable material within combustible smoking articles. This higher water and/or aerosol-generating agent content can increase the risk of condensate collecting within the aerosol provision device during use, particularly in locations away from the heating unit(s).

The inventors consider that this problem may be greater in devices with enclosed heating chambers. In such devices, the heating chamber may be fluidically connected with the exterior of the device by a conduit, for example an inlet or outlet conduit. Having studied the results of tests of devices having such conduits, the inventors consider that there is a particular risk that condensate collects within the conduits.

Such collected condensate may, in some cases, leak out of the device, leading to a less pleasant smoking experience for the user. In addition, or instead, such condensate may dry out over time, potentially forming a gum on the interior surfaces of the conduits. This gum may be difficult to remove and may therefore agglomerate over time. Furthermore, where the aerosol-generating material is contained within a consumable, the gum may adhere to the consumable, potentially discolouring it or hindering its removal after use.

The inventors have, however, determined that, by configuring the device so that the interior surface of a given conduit is heated during a session of use, the accumulation of condensate within the conduit in question may be limited and, in some cases, substantially prevented. In particular, the deposition of condensate on the interior surfaces of the conduit may be reduced.

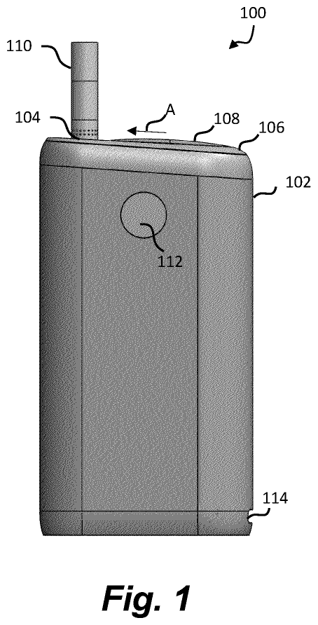

Reference is directed to FIG. 1, which is a side view of an example of an aerosol provision device 100 for generating aerosol from an aerosol-generating medium/material. In broad outline, the device 100 may be used to heat a replaceable article 110 comprising the aerosol-generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

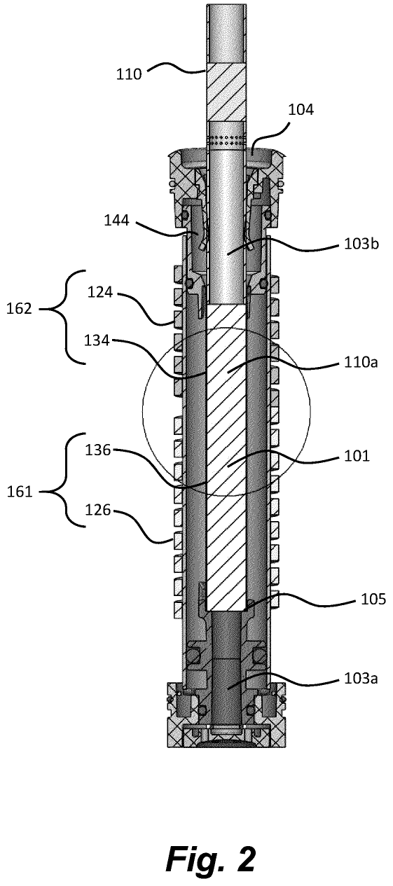

FIG. 2 depicts a cross-section of selected internal components of the device 100 of FIG. 1. As shown, the device 100 includes a heating chamber 101 for receiving the aerosol-generating material 110a. The device 100 additionally includes an inlet conduit 103a, which fluidically connects the heating chamber 101 with the exterior of the device 100. During use, air may be drawn into the device 100, flowing along inlet conduit 103a prior to flowing into heating chamber 101.

As is apparent from FIG. 2, the width of the inlet conduit 103a may be different from, for example less than, the width of the heating chamber 101. For instance, an average width value of the inlet conduit 103a may be less than an average width value of the heating chamber 101. This may, for example, provide the user with a desirable amount of draw or impedance to flow.

The device 100 further includes an outlet conduit 103b, which fluidically connects the heating chamber 101 with the exterior of the device 100 (and which, in the particular example shown, includes an expansion chamber 144). During use, aerosol generated within the heating chamber 101 may flow along outlet conduit 103b prior to flowing out of the device 100.

As is apparent from FIG. 2, the width of the outlet conduit 103b may be different from, for example greater than, the width of the heating chamber 101. For instance, an average width value of the outlet conduit 103b may be greater than an average width value of the heating chamber 101. This may, for example, allow the aerosol to expand and cool before being inhaled by the user.

As also shown in FIG. 2, the device 100 includes two heating units 161, 162 for heating the aerosol-generating material 110a. Although the illustrated example includes two heating units 161, 162, it should be understood that this is by no means essential and the device 100 could include only one heating unit, or could include three or more heating units, as appropriate.

The inventors have studied the results of tests of devices of similar construction to the device 100 of FIGS. 1 and 2. Based on these test results, the inventors foresee a particular risk that condensate collects within conduits that fluidically connect the heating chamber 101 with the exterior of the device, such as inlet conduit 103a and outlet conduit 103b.

A possible contributing factor is that, in some cases, unheated portions of the complete path through the device may experience a pressure drop, in comparison to the heated portions, including, in particular, the heating chamber. Therefore, any condensate formed in the device would tend, owing to the pressure differential with the hot heating chamber, to move towards the cooler regions upstream and downstream of the heating chamber, i.e. the inlet and outlet conduits 103a, 103b.

A further possible contributing factor is that, in some cases, the device 100 may be designed to offer resistance or impedance to the flow of air into the device, so as to regulate the flow of air through the device 100; such resistance/impedance may hinder the exit of condensate-forming substances from the inlet conduit 103a and/or outlet conduit 103b.

An additional contributing factor, in the case of the inlet conduit 103a, is that, in many cases, for condensate-forming substances to exit the inlet conduit 103a would involve them travelling in the opposite direction to the flow of air along the inlet conduit 103a during use.

Without seeking to be bound by this understanding of the contributing factors, the inventors have determined that, by configuring the device 100 so that the interior surface of one or both of the inlet conduit 103a and the outlet conduit 103b is heated during a session of use, the accumulation of condensate within the conduit(s) in question may be limited and, in some cases, substantially prevented. Such heating of the interior surface of the inlet conduit 103a and/or outlet conduit 103b may encourage condensate to re-evaporate, assisting the exit of condensate-forming substances from the inlet conduit 103a and/or outlet conduit 103b. Additionally or alternatively, such heating of the interior surface of the inlet conduit 103a and/or outlet conduit 103b may cause the air within the conduit in question to be heated, thereby increasing the amount of moisture retained by the air and thus reducing the likelihood that condensate forms in the conduit in question.

In devices according to one aspect of this disclosure, the heating of the interior surface results in at least a portion of the interior surface attaining a temperature greater than or equal to 85° C. The inventors consider that attaining a temperature of 85° C. for at least a portion of the interior surface will in many cases be sufficient to cause significant re-evaporation of condensate. Nonetheless, in some cases, the device may be configured to attain a temperature of at least 90° C. for at least a portion of the interior surface, in other cases at least 95° C., in still other cases at least 100° C. As may be appreciated, this may encourage condensate to re-evaporate, assisting the exit of condensate-forming substances from the inlet conduit.

In devices according to another aspect of this disclosure, the heating of the interior surface results in a middle portion of the interior surface, which is mid-way between first and second ends of the conduit in question, attaining a temperature greater than or equal to 70° C. The temperature of this middle portion is considered to be technically significant, as it may be generally representative of the degree of heating provided by the interior surface to the condensate, as compared with, for example, the temperature of the portion at the end nearest the heating chamber, where the condensate may additionally be heated by residual heat from the heating chamber. The inventors consider that attaining a temperature of at least 70° C. in the middle portion of the interior surface will in many cases be sufficient to cause significant re-evaporation of condensate. Nonetheless, in some cases, the device may be configured to attain a temperature of at least 80° C. in the middle portion of the interior surface, in other cases at least 90° C., in still other cases at least 100° C.

As mentioned above, heating of the interior surface of the inlet conduit 103a and/or outlet conduit 103b may cause the air within the conduit in question to be heated, thereby increasing the amount of moisture retained by the air and thus reducing the likelihood that condensate forms in the conduit in question. The inventors accordingly envisage that, in some devices in accordance with the aspects mentioned above, heating of the interior surface of the inlet conduit 103a and/or outlet conduit 103b may cause the air within the conduit in question to be heated to a temperature greater than or equal to 120° C. The inventors consider that attaining such an air temperature will, in many cases, be sufficient to materially reduce the likelihood that condensate forms in the conduit in question. Nonetheless, the inventors consider that, in other cases, it may be appropriate to configure the device such that the air is heated to a temperature of greater than or equal to 150° C., or, in still other cases, greater than or equal to 170° C., or, in yet further cases, greater than or equal to 200° C.

Returning now to FIGS. 1 and 2, it should be noted that, in the particular example device shown, the heating units 161, 162 are inductive heating units. Inductive heating units may provide rapid heating of aerosol-generating material. However, the inventors consider such rapid heating may be a risk factor for the accumulation of condensate, for example because inductive heating units may generate condensate-forming substances at a greater rate than they can be carried away.

In the particular example device 100 shown in FIG. 2, each inductive heating unit 161, 162 comprises a respective coil 124, 126 and a respective heating element 134, 136. In the particular example shown, the electrically conductive heating elements 134, 136 of the two heating units 161, 162 correspond to respective sections of a single metal tube 132. However, in other examples, each heating element may be a separate and distinct structure. More generally, it should be understood that the device may include any suitable number of heating elements for heating the aerosol-generating material; for instance, two, three or more heating elements may be provided.

In general, the coil of an inductive heating unit may, for example, be configured to cause heating of one or more electrically-conductive heating elements, for instance so that heat energy is conductible from such electrically-conductive heating elements to aerosol-generating material to thereby cause heating of the aerosol-generating material. An inductive heating unit may be configured to cause the coil to generate a varying magnetic field for penetrating the at least one heating element, to thereby cause induction heating of the at least one heating element. In the device 100 shown in FIG. 2, the coil 124, 126 of each inductive heating unit 161, 162 causes heating of its corresponding electrically-conductive heating element 134, 136. Each heating element 134, 136 then conducts heat to the aerosol-generating material 110a.

As will be appreciated, heating units other than induction heating units might be employed in other examples. For instance, the device might include one or more resistive heating units. As an example, a resistive heating unit could be substituted for each of inductive heating units 161, 162. A resistive heating unit may comprise (or consist essentially of) one or more resistive heating elements. By “resistive heating element”, it is meant that on application of a voltage to the element, current flows within the element, with electrical resistance in the element transducing electrical energy into thermal energy which heats the aerosol-generating substrate. A resistive heating element may, for example, be in the form of a resistive wire, mesh, coil and/or a plurality of wires. The heat source may be a thin-film heater.

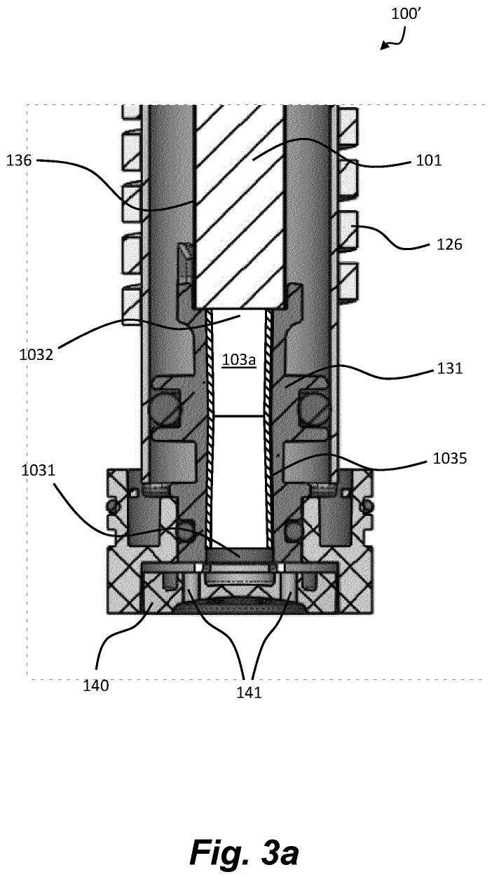

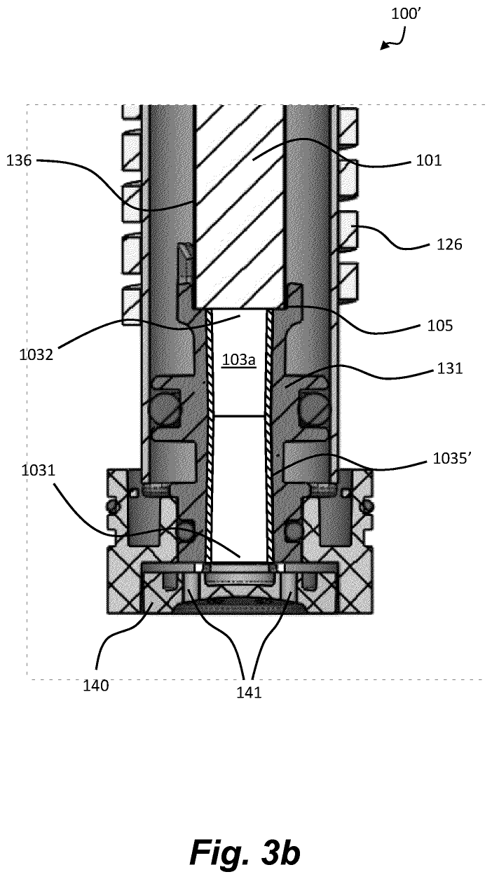

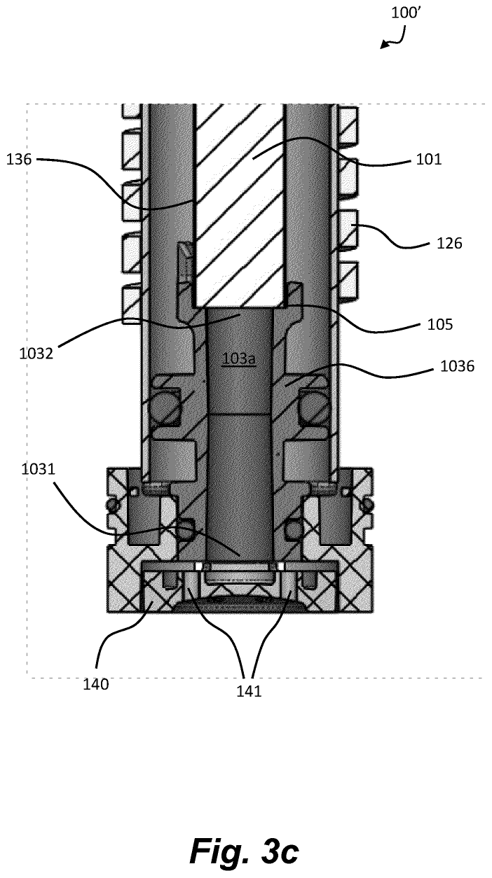

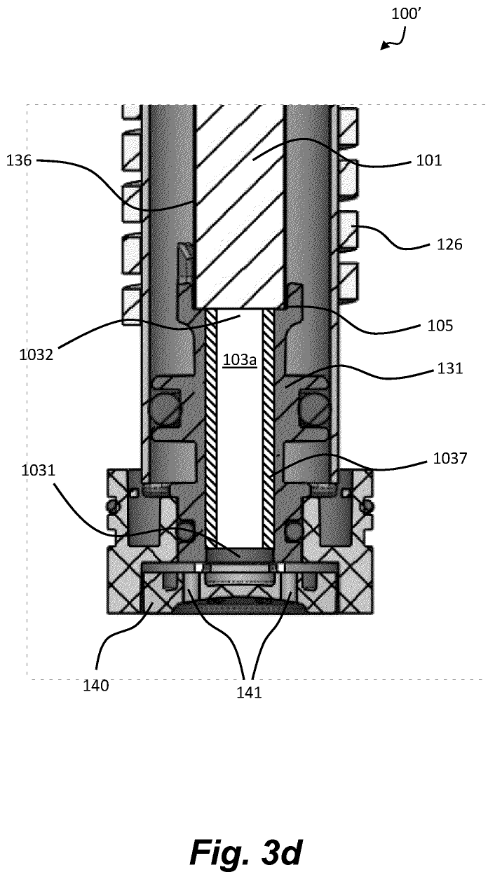

Reference is now directed to FIG. 3a which is close-up view of a cross-section through a modified version 100′ of the device 100 of FIGS. 1 and 2. In the device 100′ shown in FIG. 3a, a portion 1035 of the the interior surface of inlet conduit 103a is thermally conductive. Based on experimental testing, the inventors consider that the thermally conductive portion 1035 may suitably have a thermal conductivity greater than 1 W/m/K. For instance, a thermally conductive ceramic, such as zirconia or alumina might be employed. Such thermal conductivity may assist in transferring heat from the heating chamber 101, by conduction. The transferred heat may then encourage condensate to re-evaporate, assisting the exit of condensate-forming substances from the inlet conduit 103a.

In some cases, the device 100 may be constructed so that the thermally conductive portion's thermal conductivity is greater than or equal to 5 W/m/K, for example where ceramic materials with higher thermal conductivity (e.g. alumina, or aluminum nitride) are used to form the thermally conductive portion of the interior surface of the inlet conduit 103a. In some cases, the device 100 may be constructed so that the thermally conductive portion's thermal conductivity is greater than 10 W/m/K, for example where metallic materials, e.g. metals or alloys, are used to form the thermally conductive portion of the interior surface of inlet conduit 103a. Illustrative examples of suitable metallic materials include brass, copper, aluminium, and steel, e.g. stainless steel. (It may be noted that most metals and most steels have thermal conductivity greater than 10 W/m/K). In other cases, the device may be constructed so that the thermally conductive portion's thermal conductivity is greater than 20 W/m/K, or greater than 50 W/m/K, for example, where metallic materials such as brass, copper, aluminium are used. (It may be noted that, for example, aluminium and aluminium alloys typically have a thermal conductivity considerably greater than 100 W/m/K).

It should be appreciated that, although FIG. 3a illustrates an example where a portion 1035 of the the interior surface of inlet conduit 103a is configured to be thermally conductive, a portion of the interior surface of the outlet conduit 103b could be configured to be thermally conductive using essentially the same approach, e.g. by using the materials described above.

The device 100′ of FIG. 3a may therefore more generally be viewed as an example of a device in which the heating of the interior surface of a conduit during a session of use results, at least in part, from conduction of heat generated by the heating unit. Still more generally, this may be viewed as just one way in which the device may be configured such that the interior surface of a conduit is heated during a session of use.

Returning to the particular example illustrated in FIG. 3a, it may be noted that the thermally conductive portion 1035 of the interior surface of inlet conduit 103a is conveniently provided by a coating of thermally conductive material on an inlet conduit support 131. As shown in FIG. 3a, this inlet conduit support 131 may, for example, provide the remainder of the interior surface of the inlet conduit 103a. In some examples, the inlet conduit support 131 may be made by molding and hence (or otherwise) may suitably be constructed from a moldable polymeric material, such as polyether ether ketone (PEEK). Hence, or otherwise, the inlet conduit support 131 may, in some examples be integrally-formed (for example, being constructed from a single homogenous material); nonetheless, in other examples, the inlet conduit support 131 may comprise plural components and/or may be of composite construction.

Furthermore, although the device 100′ includes only a single portion of thermally conductive material, coating 1035, in other examples the device might include plural portions of thermally conductive material, each of which provides a respective portion of the interior surface of conduit 103a. Different portions of thermally conductive material may comprise different (thermally conductive) materials.

It may be noted that, in the particular device 100′ shown in FIG. 3a, the distal end of coating 1035 is located proximally of the distal end 1031 of the inlet conduit 103a. This may, for example, reduce the risk of the user coming into contact with a hot surface of the device. For the same reasons, in devices having multiple portions of thermally conductive material that provide part of the inner surface of inlet conduit 103a, such portions of thermally conductive material may have their distal ends located proximally of the distal end 1031 of the inlet conduit 103a.

It may also be noted that, in the particular device 100′ shown in FIG. 3a, the coating 1035 extends to the proximal end 1032 of the inlet conduit 103a. This may assist the thermally conductive material of the coating in transferring heat away from the heating chamber 101, particularly (but not exclusively) where the proximal end of the inlet conduit abuts the distal end of heating chamber 101, as is the case in FIG. 3. In general, in devices having one or more portions of thermally conductive material that provide part of the inner surface of inlet conduit 103a, at least some of these portions may extend to the proximal end of the inlet conduit so as to assist in heat transfer.

Referring once more to FIG. 3a, it may be noted that the particular example device 100′ shown includes a number of apertures 141, each of which opens, on one side, to the distal end 1031 of the inlet conduit 103a, and, at an opposite side, to the exterior of the device. Accordingly, such apertures 141 may, for example, be described as fluidically connecting the inlet conduit to the exterior of the device. During use of the device, air may flow into the inlet conduit 103a through these apertures 141. Such apertures 141 may provide suitable impedance to the flow of air into the device, so as to regulate the flow of air through the device 100. However, such impedance may equally increase the risk that condensate collects within the inlet conduit 103a. Nonetheless, by configuration of the device 100′, in accordance with one of the aspects of this disclosure, the accumulation of condensate within the inlet conduit may be limited and, in some cases, substantially prevented.

While a coating 1035 is referred to herein, it will of course be appreciated this is merely an example of a layer (and, more particularly, a conformal layer) of thermally conductive material providing the thermally conductive portion 1035 of the interior surface of inlet conduit 103a. Accordingly, the teaching is not limited to layers formed by coating techniques. As will be understood, there are many techniques for forming a conformal layer of material, such as physical or chemical deposition techniques; as a particular example, plating techniques (e.g. electro-plating) might be used to form a layer of thermally conductive material.

Furthermore, while in the device 100′ only a portion of the interior surface of inlet conduit 103a is thermally conductive, it should be understood that, in other examples, substantially the entirety of the interior surface might be thermally conductive, having a thermal conductivity greater than 1 W/m/K, 5 W/m/K (or 20 W/m/K, or 50 W/m/K, depending on the particular arrangement). Such an example is shown in FIG. 3b, where coating 1035′ extends all the way to the distal end 1031 of inlet conduit 103a.

Moreover, it is of course by no means essential that the device includes a conformal layer of thermally conductive material, such as a coating 1035. Indeed, there are various constructional approaches to providing a thermally conductive portion of the interior surface of inlet conduit 103a. As one example, the device might include a liner in the inlet conduit 103a.

As a further example, the device might include a tubular/cylindrical component 1036 constructed entirely of thermally conductive material (for example: a metallic material, such as a metal or an alloy, illustrative examples of suitable metallic materials including brass, copper, aluminium, and steel, e.g. stainless steel; or a thermally conductive ceramic material, such as as zirconia or alumina), with the thermally conductive portion of the interior surface of the inlet conduit 103a being provided by the tubular component. Such an example is shown in FIG. 3c, where the device includes tubular component 1036, which defines the entirety of the interior surface of inlet conduit 103a. In a particular example, the tubular component 1036 might suitably be constructed entirely from metallic materials such as brass, aluminium, steel (e.g. stainless steel), and/or copper. In the particular example shown, the tubular component 1036 has generally the same shape as the inlet conduit support 131 shown in FIGS. 3a and 3b, and therefore connects to and supports other components in the device, including the metal tube 132 that provides the two heating elements 134, 136; however, this is of course not essential, and the tubular component 1036 could have any appropriate shape.

A still further example of a construction that provides a thermally conductive portion of an interior surface of an inlet conduit 103a is shown in FIG. 3d, where a tubular component 1037 constructed entirely of thermally conductive material (for example: a metallic material, such as a metal or an alloy, illustrative examples of suitable metallic materials including brass, copper, aluminium, and steel, e.g. stainless steel; or a thermally conductive ceramic material, such as as zirconia or alumina), is provided as an insert within another component, which may, for instance, be constructed of thermally insulating materials, such as polymeric materials. In the particular example shown in FIG. 3d, tubular component 1037 is provided as an insert within inlet conduit support 131, which, as noted above, may be made of moldable polymeric material, such as polyether ether ketone (PEEK). The tubular component 1037 might suitably be constructed entirely from metallic materials such as brass, aluminium, steel (e.g. stainless steel), and/or copper.

It should also be understood that any of the approaches described above for providing a thermally conductive portion 1035 of the the interior surface of inlet conduit 103a could equally be adopted to provide a thermally conductive portion of the interior surface of outlet conduit 103b. Thus, outlet conduit 103b could, for example, include a coating 1035, tubular/cylindrical component 1036 and/or tubular insert 1037 as described above.

Furthermore, while coating 1035, tubular/cylindrical component 1036 and tubular insert 1037 have been described as being formed of a thermally conductive material, it should be understood that they could also be formed of an electrically conductive material, such as a metallic material, for example a metal or an alloy. Illustrative examples of suitable metallic materials include brass, copper, aluminium, and steel (e.g. stainless steel). These should more generally be understood as examples of devices in which at least a portion of the interior surface of inlet conduit is formed of electrically conductive material. Furthermore, it should be appreciated that, where such devices include at least one inductive heating unit that heats the device's heating chamber (such as inductive heating units 161, 162 of device 100′) the inductive heating unit may also cause the electrically conductive portion of the interior surface of inlet conduit to be inductively heated. Still further, this electrically conductive portion may, in some examples, be formed of ferromagnetic and/or ferrimagnetic material, so as to be additionally be heated as a result of magnetic hysteresis losses.

Still more generally, such inductive heating may be viewed as an additional (or alternative) way in which the interior surface of a conduit may be heated during a session of use.

With the benefit of the teaching of this disclosure, further ways of heating the interior surface of an inlet or outlet conduit during a session of use should be apparent. For instance, in other examples, one or more dedicated heating units could be provided for heating the interior surface of a conduit.

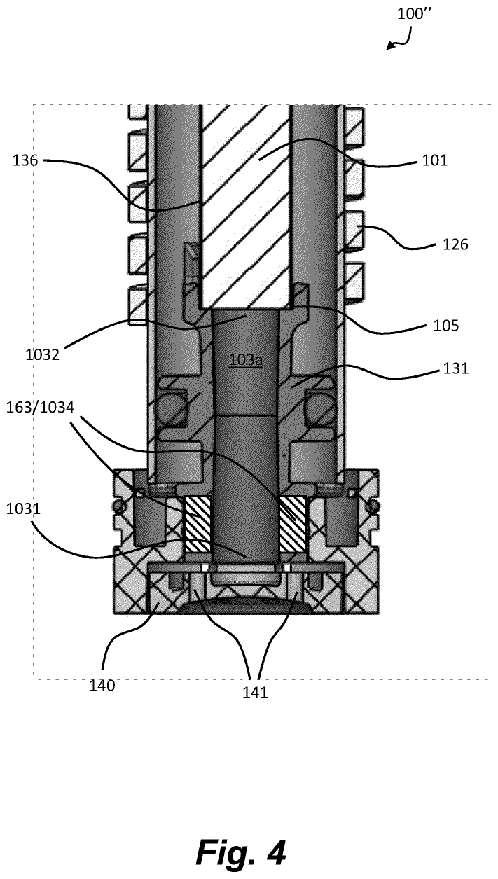

Moreover, in accordance with a further aspect of this disclosure, it is envisaged that a heating unit may be provided that heats the air within an inlet or an outlet conduit. In this regard, reference is directed to FIG. 4, which shows a device 100″ according to this aspect of this disclosure. In general, the device 100″ is a modified version of the device 100 of FIGS. 1 and 2.

Notably, the device 100″ includes an air heating unit 163 for heating air within the inlet conduit 103a. In accordance with the present aspect of the disclosure, this heating of air within the conduit 103a substantially prevents accumulation of condensation within the conduit 103a. In particular examples, the air is heated to a temperature of greater than or equal to 120° C. The inventors consider that attaining such an air temperature will, in many cases, be sufficient to substantially reduce the likelihood that condensate forms in the conduit in question. Nonetheless, the inventors consider that, in other cases, it may be appropriate to configure the device 100″ such that the air is heated to a temperature of greater than or equal to 150° C., or, in still other cases, greater than or equal to 170° C., or, in yet further cases, greater than or equal to 200° C.

Although in the example device 100″ of FIG. 4 the heating unit 163 is arranged so as to heat air within the inlet conduit 103a of the device 100″ it should be understood that, in other examples, a similar heating unit could be provided to heat air within the outlet conduit 103b. Indeed, in still further embodiments, respective air heating units could be provided for the inlet and outlet conduits 103a, 103b.

In the particular example shown in FIG. 4, the air heating unit 163 includes a resistive heating element 1034. Resistive heating elements may be suitable because they are relatively compact. However, devices according to further examples might utilise other types of heating element.

As illustrated in FIG. 4, the heating element 1034 may, for example, define a portion of the interior surface of the inlet conduit 103a. However, this is not essential and in other examples other components may define the interior surface of the conduit. In such examples, the heating element might, for instance, be arranged so as to transfer heat to the conduit-defining components by conduction. The conduit-defining components might therefore be constructed from one of the thermally conductive materials discussed above.

As is apparent from FIG. 4, the heating element 1034 extends circumferentially around inlet conduit 103a. However, in other examples, the heating element(s) of the heating unit 163 could instead be provided at an end of the conduit 103a, for example the end furthest from the heating chamber 101. In such examples, the heating element(s) might be arranged such that air passes through or between the heating element(s) when entering the conduit (in the case of an inlet conduit 103a) or when leaving the conduit (in the case of an outlet conduit 103b). In a particular example, the heating element(s) could be provided on or in a cap 140 or door that separates the conduit from the exterior of the device.

As also shown in FIG. 4, the heating element 1034 is spaced from the exterior of the device, for example such that it is inaccessible to the user during use of the device 100″. Arranging the heating element(s) of the heating unit 163 such that they are spaced from the exterior of the device may, for example, reduce the risk of the user coming into contact with a hot surface of the device 100″.

In a number of examples, the air heating unit 163 is controlled separately from the heating unit(s) 161, 162 that heat aerosol-generating material within the heating chamber 101 of the device 100″. As a result, the air heating unit 163 may be operated at different times to the heating unit(s) 161, 162 for the heating chamber 101. In general, the heating unit(s) 161, 162 for the heating chamber 101 may be activated prior to the air heating unit 163 for the conduit 103a, for example because condensation is not expected to be formed until the aerosol-generating material has been heated for a meaningful period of time.

It is further envisaged that the air heating unit 163 may be controlled in dependence upon the output from one or more sensors. The output from the one or more sensors may, in some examples, be provided to a controller, such as a microcontroller, which in turn controls the air heating unit 163 based on such output, or, in other examples, may be provided directly to the air heating unit 163, which may, for instance include suitable logic circuitry to control the operation of the air heating unit 163.

In one example, the one or more sensors may comprise one or more sensors that sense whether aerosol-generating material is present within the heating chamber 101 used. Such sensors might, for example, include pressure sensors arranged such that any aerosol-generating material present in the chamber applies pressure to them, or optical sensors arranged such that any aerosol-generating material reduces the amount of light reaching the optical sensors. The output from such sensors may be used to control the air heating unit 163 such that it heats air within the conduit (e.g. to above a threshold temperature) in response to the sensor output indicating that aerosol-generating material has been removed from the heating chamber. In such an example, the air heating unit 163 may assist in removing moisture from the device 100″ that was generated during a session of use by the user.

In another example, the one or more sensors may comprise one or more sensors that sense whether the user is inhaling aerosol generated by the device. Such sensors might, for example, sound sensors (e.g. microphones) or air pressure sensors. The output from such sensors may be used to control the air heating unit 163 such that it heats air within the conduit (e.g. to above a threshold temperature) in response to the sensor output indicating that the user has inhaled aerosol. For example, the air heating unit 163 may achieve the threshold temperature shortly after the user finishes inhaling. Hence, or otherwise, the air heating unit 163 may be operated between puffs by the user.

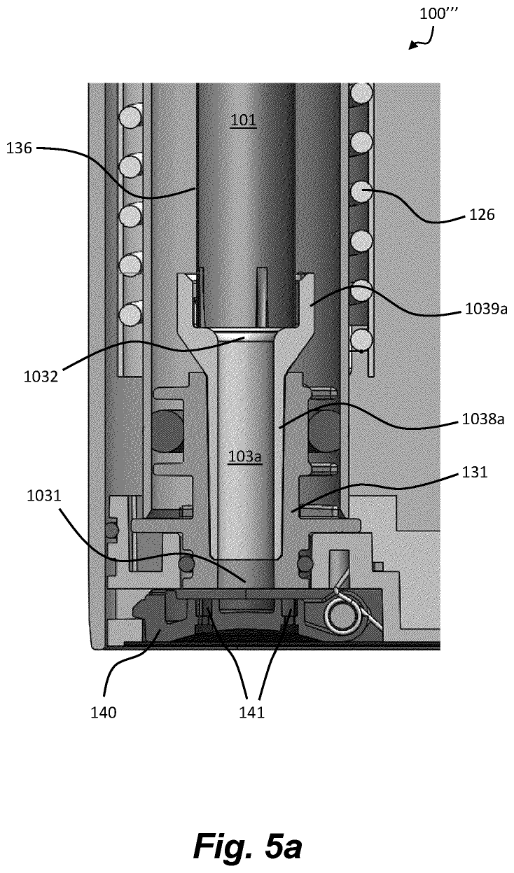

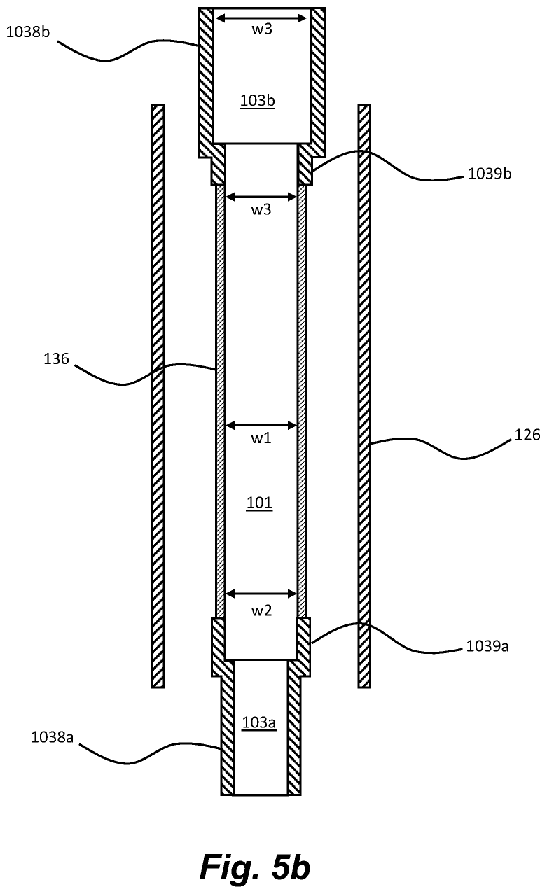

Attention is now directed to FIG. 5a, which shows a device 100′″ according to a further aspect of this disclosure, in which a component 1038a defining at least a portion of the inlet conduit 103a includes a susceptor 1039a that is heatable by an inductor 126. As shown in FIG. 5a, the susceptor 1039a may, for example, surround a part of the inlet conduit.

In the particular example shown in FIG. 5a, the entirety of component 1038a is constructed of the same electrically conductive material. For instance, component 1038a might be formed of a metallic material, e.g. a metal or metal alloy. Illustrative examples of suitable metallic materials include brass, copper, aluminium, and steel, e.g. stainless steel. Nonetheless, in other examples, the susceptor 1039a could be constructed from different materials as compared with the other parts of the component 1038a.

As shown in FIG. 5a, in some embodiments the susceptor 1039a may simply correspond to a proximal portion of component 1038a that is surrounded by the inductor 126. In still other examples, the susceptor 1039a might make up substantially the entirety of the component 1038a. In one such example, the inductor 126 might extend beyond the distal end of inlet conduit-defining component 1038a, to surround the entirety of component 1038a, rather than just a proximal portion thereof, as is the case in FIG. 5a.

It may be noted that, in the particular example shown in FIG. 5a, susceptor 1039a abuts susceptor 136. As a result, susceptor 1039a is additionally heated by thermal conduction from susceptor 136. However, this is not essential and, in other example devices according to the present aspect, susceptor 1039a and susceptor 136 could be spaced apart from one another and, indeed, could be thermally insulated from one another.

It may further be noted that, as shown in FIG. 5a, the proximal end of component 1038a circumferentially surrounds the distal end of the susceptor 136. This may assist in reliably positioning the susceptor 136 during assembly of the device and/or may provide effective heat conduction from the susceptor to component 1038a.

As also shown in FIG. 5a, the device 100′″ may additionally include a support 131 that comprises (or is constructed substantially entirely of) thermally insulating material. For example, support 131 might comprise (or be constructed substantially entirely of) plastic or polymeric material, such as a moldable polymeric material, e.g. polyether ether ketone (PEEK). As is apparent, support 131 includes a passageway that extends between two ends of the support 131, with component 1038a being located within this passageway.

As also shown in FIG. 5a, susceptor 1039a, and component 1038a in general, is spaced from the outermost end of the passageway within support 131. This may, for example, reduce the risk of the user coming into contact with a hot surface of the device.

It will further be noted that, in the particular example shown in FIG. 5a, inductor 126 is operable to cause heat to be generated within both susceptor 1039a (thereby causing heating of the inlet conduit 103) and susceptor 136 (thereby causing heating of heating chamber 101). However, it is envisaged that, in some embodiments according to this aspect of the disclosure, the heating chamber 101 might instead be heated by a separate, dedicated heating unit. Thus, for example, a separate inductor could be provided to generate heat within susceptor 136. Additionally, or alternatively, susceptor 1039a might be configured so as to be inherently less susceptible to inductive heating than susceptor 136. For example, the susceptor 1039a might be constructed from a material that is inherently less susceptible to inductive heating than the material from which susceptor 136 is constructed. In one example, susceptor 1039a might be constructed from stainless steel and susceptor 136 might be constructed from mild or carbon steel.

Moreover, in some embodiments, the heating unit for the heating chamber 101 might not be an inductive heating unit; it could instead be a resistive heating unit, for instance. Therefore, the device could, for example, include a resistive heating element, such as a coil of resistive heating wire, or one or more interconnected conductive tracks provide on a substrate (e.g. forming part of a film heater).

More generally, it is envisaged that any of the approaches described above for inductively heating the inlet conduit 103a may, additionally or alternatively, be employed to heat an outlet conduit 103b. In this regard, reference is directed to FIG. 5b, which is a schematic diagram of a device where both an inlet conduit-defining component 1038a and an outlet conduit-defining component 1038b are inductively heated. While FIG. 5b shows a device in which both an inlet conduit-defining component 1038a and an outlet conduit-defining component 1038b are inductively heated, it should be understood that the device could equally be configured such that only the outlet conduit-defining component 1038b is inductively heated.

Referring to FIG. 5b, as may be seen, outlet conduit-defining component 1038b includes a portion (or part) that acts as a susceptor 1039b, so as to be inductively heated by inductor coil 126. In the particular example shown, inductor coil 126 causes the inductive heating of susceptor 136, which heats the heating chamber 101 (and any aerosol-generating material within it), the inductive heating of susceptor 1039b of outlet conduit-defining component 1038b, and the inductive heating of susceptor 1039a of outlet conduit-defining component 1038a. However, this is by no means essential and, in other embodiments, respective inductor coils could be provided to cause inductive heating of the inlet conduit-defining component 1038a and outlet conduit-defining component 1038b. Furthermore, as noted above, the heating chamber 101 may also be provided with a dedicated heating unit, which need not be inductive; the heating chamber 101 might, therefore, be heated by one or more resistive heating elements in some embodiments.

Still further, in some embodiments one or both of the susceptors 1039a, 1039b of the conduit-defining components 1038a, 1038b may be configured so as to be inherently less susceptible to inductive heating than susceptor 136, which heats the heating chamber 101. For example, they might be constructed from a material that is inherently less susceptible to inductive heating than the material from which susceptor 136 is constructed. In one example, they might be constructed from stainless steel, while susceptor 136 might be constructed from mild or carbon steel.

Still further, in devices according to this aspect of this disclosure, the heating of the susceptor may result in an interior surface of the associated inlet or outlet conduit attaining a temperature greater than or equal to 85° C. As noted above, the inventors consider that attaining a temperature of 85° C. for at least a portion of the interior surface will in many cases be sufficient to cause significant re-evaporation of condensate. Nonetheless, in some cases, the device may be configured to attain a temperature of at least 90° C. for at least a portion of the interior surface, in other cases at least 95° C., in still other cases at least 100° C.

Alternatively, or additionally, in devices according to this aspect of this disclosure, the heating of a conduit may result in a middle portion of its interior surface, which is mid-way between first and second ends of the conduit in question, attaining a temperature greater than or equal to 70° C. The temperature of this middle portion is considered to be technically significant, as it may be generally representative of the degree of heating provided by the interior surface to the condensate, as compared with, for example, the temperature of the portion at the end nearest the heating chamber, where the condensate may additionally be heated by residual heat from the heating chamber. The inventors consider that attaining a temperature of at least 70° C. in the middle portion of the interior surface will in many cases be sufficient to cause significant re-evaporation of condensate. Nonetheless, in some cases, the device may be configured to attain a temperature of at least 80° C. in the middle portion of the interior surface, in other cases at least 90° C., in still other cases at least 100° C.

Returning to FIG. 5b, it may be noted that the width of the heating chamber 101 is substantially constant over its length. Thus, the heating chamber's width w2 at is distal end is substantially the same as its width w3 at its proximal end and its width w1 at its middle. However, this is not essential. In other examples, the width of the chamber may increase from its middle towards its proximal and/or distal ends (e.g. so that the chamber is hourglass-shaped). Particularly (but not exclusively) where the heating elements for the chamber surround or define the chamber, the greater width of the proximal and distal end portions of the chamber may result in the proximal and/or distal ends of the smoking article receiving less heating. Reduced heating of the end portions of the article and, in particular, the end portions of the aerosol-generating material within the article, may result in those end portions acting to collect and/or absorb condensation. In addition, reduced heating of the proximal end of the article may be particularly appropriate where the article includes a filter at its proximal end, as it may reduce the risk of damage to the filter.

It should be noted that the inventors view the device 100′″ of FIG. 5a and the device 100′″ of FIG. 5b as embodying a further aspect of this disclosure, which will now be described.

As may be seen from FIG. 5a, component 1038a, which defines at least a portion of the inlet conduit 103a of the device 100′″, abuts susceptor 136. It may therefore be understood that, where this component 1038a comprises thermally conductive material it may be heated by thermal conduction from the susceptor 136. This may in turn cause heating of inlet conduit 103a, thereby assisting in preventing accumulation of condensation within the inlet conduit 103a.

In the device of FIG. 5b, both inlet conduit-defining component 1038a and outlet conduit-defining component 1038b abut susceptor 136. Thus, where components 1038a and 1038b comprise thermally conductive material, they may each be heated by thermal conduction from the susceptor 136, in turn causing heating of inlet conduit 103a and outlet conduit 103b.

According to the present aspect it is envisaged that such conducted heat may be used to heat inlet conduit 103a and/or outlet conduit 103b and to thereby prevent accumulation of condensation within the associated conduit(s) 103a, 103b, without it being necessary for the corresponding conduit-defining component(s) 1038a, 1038b to include any part that is inductively heated, such as susceptor 1039a. Furthermore, given that such inductive heating is optional in this aspect of the disclosure, the inventors envisage that the corresponding conduit-defining components 1038a, 1038b may abut a non-inductive heating element. Thus, in devices according to the present aspect, a conduit-defining component 1038a, 1038b might, for example, abut a resistive heating element, rather than abutting susceptor 136, as is shown in FIG. 5.

In the embodiment shown in FIG. 5a, component 1038a and susceptor 136 not only abut, but are also “keyed”, being rotationally locked or interlinked. Nonetheless, in other embodiments, they might be fixed to one another other to prevent relative movement in general, such as by soldering, welding, brazing, adhesion, mechanical-interlinking or otherwise.

In some embodiments, the thermally conductive material of a conduit-defining component may have a thermal conductivity of greater than or equal to 1 W/m/K, for instance where a thermally conductive ceramic, such as zirconia or alumina is employed. In other embodiments, the thermally conductive material may have a thermal conductivity of greater than or equal to 5 W/m/K, for example where ceramic materials with higher thermal conductivity (e.g. alumina, or aluminum nitride) are used. In still other embodiments, the thermally conductive material may have a thermal conductivity of greater than 10 W/m/K, for example where metallic materials, e.g. metals or alloys, are used. Illustrative examples of suitable metallic materials include brass, copper, aluminium, and steel, e.g. stainless steel. (It may be noted that most metals and most steels have thermal conductivity greater than 10 W/m/K). In still other embodiments, the thermally conductive material may have a thermal conductivity of greater than 20 W/m/K, or greater than 50 W/m/K, for example, where metallic materials such as brass, copper, aluminium are used. (It may be noted that, for example, aluminium and aluminium alloys typically have a thermal conductivity considerably greater than 100 W/m/K).

In some embodiments, substantially the entirety of a conduit-defining component 1038a, 1038b might be constructed from thermally conductive material as described above.

In devices according to this aspect of this disclosure, the heating of an inlet and/or outlet conduit may result in an interior surface of the conduit(s) in question attaining a temperature greater than or equal to 85° C. As noted above, the inventors consider that attaining a temperature of 85° C. for at least a portion of the interior surface will in many cases be sufficient to cause significant re-evaporation of condensate. Nonetheless, in some cases, the device may be configured to attain a temperature of at least 90° C. for at least a portion of the interior surface, in other cases at least 95° C., in still other cases at least 100° C.

Alternatively, or additionally, in devices according to this aspect of this disclosure, the heating of an inlet and/or outlet conduit may result in a middle portion of the interior surface of the conduit(s) in question attaining a temperature greater than or equal to 70° C. (the middle portion of a conduit being defined as the portion mid-way between first and second ends of that conduit.) The temperature of this middle portion is considered to be technically significant, as it may be generally representative of the degree of heating provided by the interior surface to any condensate, as compared with, for example, the temperature of the portion at the end nearest the heating chamber, where the condensate may additionally be heated by residual heat from the heating chamber. The inventors consider that attaining a temperature of at least 70° C. in the middle portion of the interior surface will in many cases be sufficient to cause significant re-evaporation of condensate. Nonetheless, in some cases, the device may be configured to attain a temperature of at least 80° C. in the middle portion of the interior surface, in other cases at least 90° C., in still other cases at least 100° C.

Although FIG. 5a shows inlet conduit-defining component 1038a and susceptor 136 as being rotationally locked or interlinked, they may instead, as mentioned above, be fixed to one another other to prevent relative movement in general. For example, they may be fixed together by soldering, welding, brazing, adhesion, mechanical attachment (e.g. crimping or push-fitting) or mechanical interlinking. In accordance with yet another aspect of this disclosure, it is envisaged that inlet conduit-defining component 1038a and susceptor 136 may be sealingly joined to one another (e.g. by welding, soldering, brazing, adhesive or mechanical attachment), such that a hermetic seal is provided where the heating chamber 101 and the inlet conduit 103a meet. Some embodiments may be described as providing a hermetic seal in the vicinity of a confluence or junction of the heating chamber 101 with the inlet conduit 103a.

Indeed, the same approach may be employed with respect to an outlet conduit-defining component 1038b. For example, outlet conduit-defining component 1038b in FIG. 5b may be sealingly joined to susceptor 136 such that a hermetic seal is provided where the heating chamber 101 and the outlet conduit 103b meet. Some embodiments may be described as providing a hermetic seal in the vicinity of a confluence or junction of the heating chamber 101 with the outlet conduit 103b.

It is considered that there is a particular risk of escape of condensate-forming substances where the heating chamber meets an inlet or an outlet conduit. Such substances could contaminate the space between the heating chamber 101 and an insulating member 128 (described below) that is radially outwards of the heating chamber 101, for example. Such a hermetic seal significantly reduces this risk.

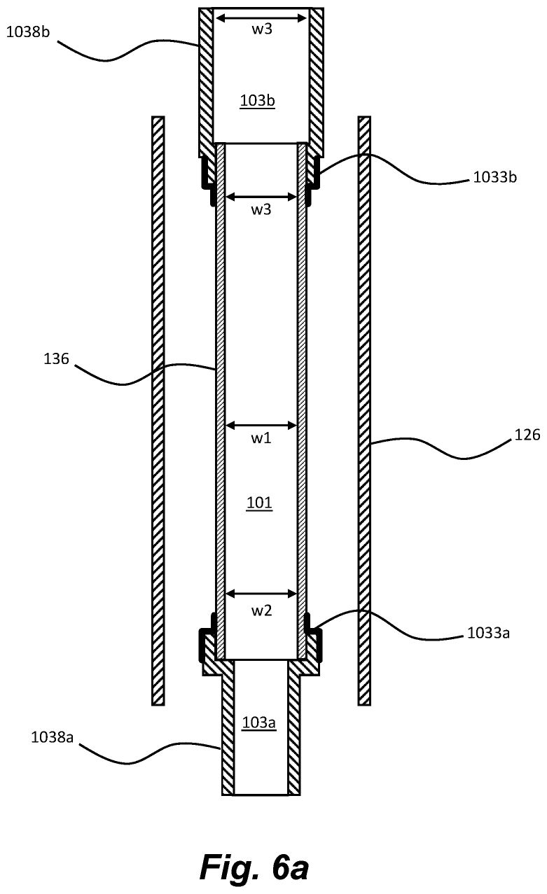

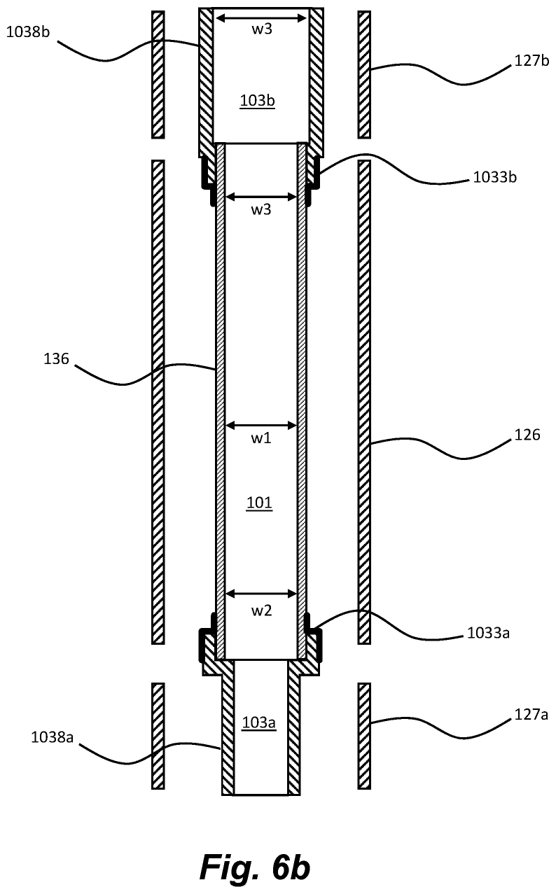

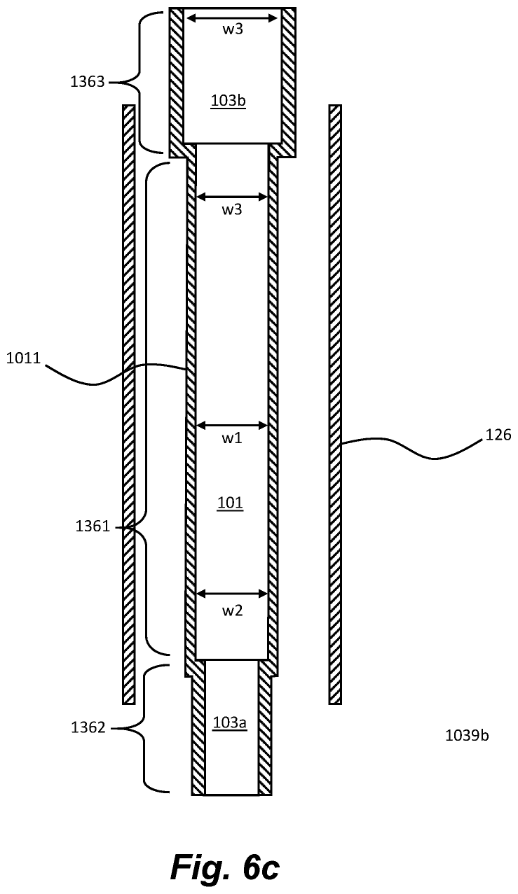

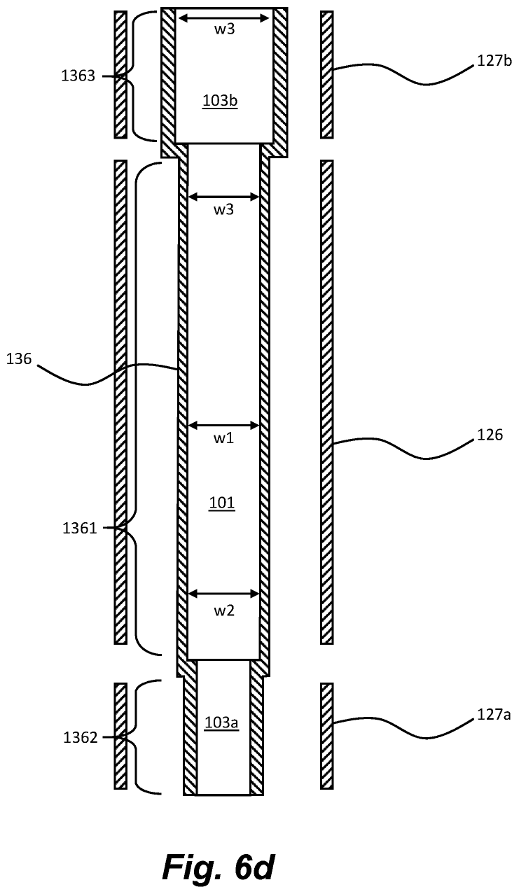

Reference is now directed to FIG. 6a, which shows a device 100 according to an embodiment of this aspect of the disclosure. As may be seen, the device 100 includes a susceptor 136, which is welded or brazed to inlet conduit-defining component 1038a at one end (as indicated by emboldened lines 1033a) and is welded or brazed to outlet conduit-defining component 1038b at the other end (as indicated by emboldened lines 1033b). As may be seen, the welding/brazing 1033a, 1033b has taken place about an exterior of the susceptor 136 and the conduit-defining components 1038a, 1038b. This avoids the welding or brazing impacting upon the shape of the interior passageway that comprises heating chamber 101 and inlet and outlet conduits 103a, 103b. However, in other embodiments, the welding or brazing could take place on the interior in addition to, or instead of, the exterior.

In some embodiments, at least a portion of the inlet conduit-defining component 1038a and/or the outlet conduit-defining component 1038b comprises (or is formed of) thermally conductive material.

In some embodiments, the thermally conductive material of a conduit-defining component may have a thermal conductivity of greater than or equal to 1 W/m/K, for instance where a thermally conductive ceramic, such as zirconia or alumina is employed. In other embodiments, the thermally conductive material may have a thermal conductivity of greater than or equal to 5 W/m/K, for example where ceramic materials with higher thermal conductivity (e.g. alumina, or aluminum nitride) are used. In still other embodiments, the thermally conductive material may have a thermal conductivity of greater than 10 W/m/K, for example where metallic materials, e.g. metals or alloys, are used. Illustrative examples of suitable metallic materials include brass, copper, aluminium, and steel, e.g. stainless steel. (It may be noted that most metals and most steels have thermal conductivity greater than 10 W/m/K). In still other embodiments, the thermally conductive material may have a thermal conductivity of greater than 20 W/m/K, or greater than 50 W/m/K, for example, where metallic materials such as brass, copper, aluminium are used. (It may be noted that, for example, aluminium and aluminium alloys typically have a thermal conductivity considerably greater than 100 W/m/K).

In some embodiments, substantially the entirety of a conduit-defining component 1038a, 1038b might be constructed from thermally conductive material as described above. In other embodiments, only a portion of the interior surface of the inlet and/or outlet conduit-defining components 1038a,1038b may be constructed from thermally conductive material.

Although heating chamber 101 is defined by susceptor 136 in the embodiment of FIG. 6a, this is by no means essential and in other embodiments the heating chamber 101 could be defined by one or more components, none of which acts as a susceptor. For instance, the components defining the heating chamber 101 might include a thermally conductive component (such as a tube formed of thermally-conductive material) upon which one or more resistive heating elements are mounted.

In the particular embodiment shown in FIG. 6a, the inlet conduit-defining component 1038a and the outlet conduit-defining component 1038b each act as a susceptor and are heatable by the same inductor 126 that causes the heating of susceptor 136. However, in other embodiments, such as that shown in FIG. 6b, each of inlet conduit-defining component 1038a and outlet conduit-defining component 1038b may be heatable by a respective, dedicated inductor 127a, 127b. In such a case, the device may be configured to individually control the heating of inlet conduit-defining component 1038a and outlet conduit-defining component 1038b.

In still other embodiments, multiple inductors may be provided for causing the heating of respective portions of the susceptor 136. For instance, multiple inductors may cause the heating of respective lengthwise portions of a susceptor 136, as is the case in the device shown in FIG. 2, which includes inductors 124 and 126. In some embodiments where multiple inductors are provided, a first inductor (or a first group of inductors) may be arranged to cause the heating of a portion of a susceptor that defines the heating chamber, as well as a portion of a susceptor that defines one of the inlet or outlet conduits. By contrast, a second inductor (or a second group of inductors) may be arranged to cause the heating of a different portion of the susceptor that defines the heating chamber, as well as a portion of a susceptor that defines the other of the inlet and outlet conduits.

Still further approaches of configuring the aerosol provision device so that the interior surface of a conduit is heated during a session of use will be apparent from the discussion further above. For instance, heat may be transferred by thermal conduction from the heating element (e.g. susceptor 136) for the heating chamber 101. Accordingly, it will be understood that it is by no means essential that inlet conduit-defining component 1038a and outlet conduit-defining component 1038b act as susceptors.

It should be understood that sealingly joining components that define a heating chamber to components that define an inlet or outlet conduit is considered just one approach for providing a hermetic seal where a heating chamber meets an inlet or outlet conduit. An alternative approach is illustrated in FIG. 6c, which shows a device which includes a unitary, or integrally-formed component 1011 that defines a heating chamber 101, an inlet conduit 103a and an outlet conduit 103b. As shown, a continuous passageway or lumen may extend through the unitary component 1011. In the embodiment shown, this passageway includes heating chamber 101, inlet conduit 103a and outlet conduit 103b. In some embodiments, this entire passageway may be hermetically sealed, so as to substantially inhibit the escape of condensate-forming substances, except from, for example, the longitudinal ends of the passageway.

Although such a passageway that is sealed along substantially its entire length is described with reference to an embodiment including a unitary component, it should be understood that such a substantially sealed passageway may equally be present in embodiments such as those shown in FIGS. 6a and 6b where multiple components define a heating chamber and inlet and/or outlet conduits.

Returning to the embodiment of FIG. 6c, it should be appreciated that the unitary component 1011 may be formed by a variety of suitable processes. For example, the unitary component 1011 may—particularly where the unitary component 1011 is formed of a metal or an alloy—be formed in a spin forming or flow forming process. In other examples, the unitary component 1011 may be formed by an additive manufacturing/3D printing process, by extrusion, or by casting.

In the particular embodiment shown in FIG. 6c, a first portion 1361 of the integrally-formed component 1011 defines the heating chamber 101 and acts as a first susceptor, which heats aerosol-generating material within the heating chamber 101. Second and third portions 1362, 1363 of the integrally-formed component 1011 define, respectively inlet conduit 103a and outlet conduit 103b and are inductively heatable by the same inductor 126 that causes inductive heating of the first portion 1361.

However, in other embodiments, such as that shown in FIG. 6d, second and third portions 1362, 1363 of the integrally-formed component 1011 may be heatable by a respective inductor 127a, 127b. In such a case, the device may be configured to individually control the heating of inlet conduit-defining component 1038a and outlet conduit-defining component 1038b.

While in the embodiments of FIGS. 6c and 6d the same integrally-formed component 1011 defines heating chamber 101, inlet conduit 103a and outlet conduit 103b, in other embodiments an integrally-formed component might instead define just heating chamber 101 and inlet conduit 103a, or just heating chamber 101 and outlet conduit 103b. In such a case, one or more separate components may define the outlet conduit 103b or inlet conduit 103a respectively, with those components for example being sealingly joined to the unitary component, for instance by welding (e.g. as described above) soldering, brazing, or adhesive.

In devices according to this aspect of this disclosure, the heating of an inlet and/or outlet conduit may result in an interior surface of the conduit(s) in question attaining a temperature greater than or equal to 85° C. As noted above, the inventors consider that attaining a temperature of 85° C. for at least a portion of the interior surface will in many cases be sufficient to cause significant re-evaporation of condensate. Nonetheless, in some cases, the device may be configured to attain a temperature of at least 90° C. for at least a portion of the interior surface, in other cases at least 95° C., in still other cases at least 100° C.

Alternatively, or additionally, in devices according to this aspect of this disclosure, the heating of an inlet and/or outlet conduit may result in a middle portion of the interior surface of the conduit(s) in question attaining a temperature greater than or equal to 70° C. (the middle portion of a conduit being defined as the portion mid-way between first and second ends of that conduit.) The temperature of this middle portion is considered to be technically significant, as it may be generally representative of the degree of heating provided by the interior surface to any condensate, as compared with, for example, the temperature of the portion at the end nearest the heating chamber, where the condensate may additionally be heated by residual heat from the heating chamber. The inventors consider that attaining a temperature of at least 70° C. in the middle portion of the interior surface will in many cases be sufficient to cause significant re-evaporation of condensate. Nonetheless, in some cases, the device may be configured to attain a temperature of at least 80° C. in the middle portion of the interior surface, in other cases at least 90° C., in still other cases at least 100° C.

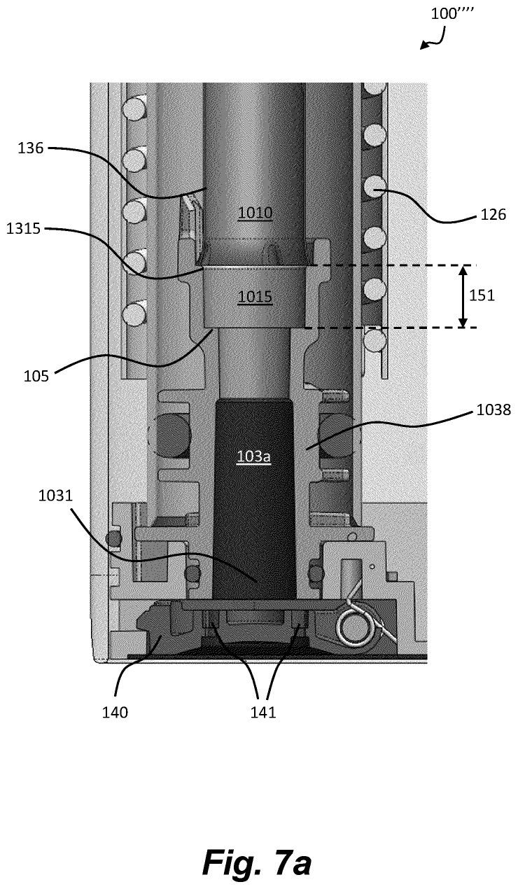

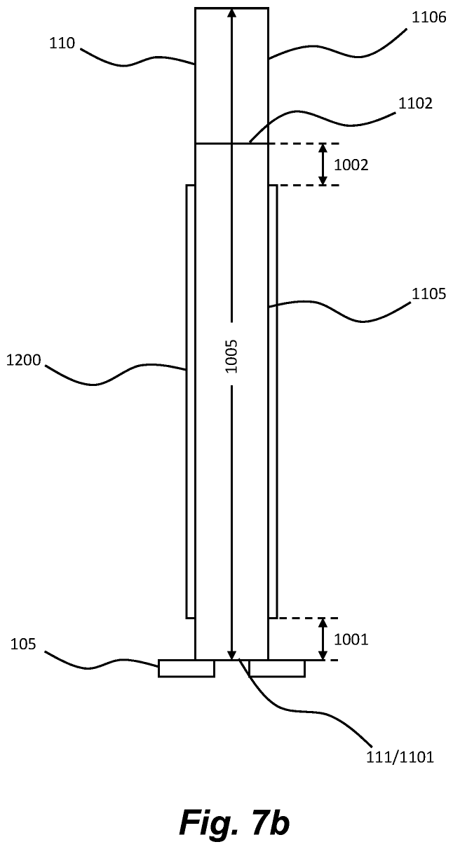

Reference is now directed to FIG. 7a, which shows a device 100″″ according to a still further aspect of this disclosure. Similarly to the devices shown in FIGS. 1-5d, the device 100″″ of FIG. 7a is configured to receive an article 110 comprising aerosol-generating material and the device 100″″ is configured to generate aerosol from the aerosol-generating material 1105 when the article 110 is received within the device 100″″. The device 100″″ accordingly includes a heating assembly for heating the aerosol-generating material 1105 during a session of use. The heating assembly includes at least one heating element, such as a susceptor 136, as in shown in FIG. 7a.

The device of FIG. 7a further includes a stop 105. Stop 105 prevents a distal end of the article 110 from moving distally beyond a limit position when the article 110 is inserted in the aerosol provision device. As may be seen, in the particular example shown in FIG. 7, stop 105 defines a limit position that is located distally of the distal end of the susceptor 136. By contrast, in the devices shown in FIGS. 1-5b, the stop 105 defines a limit position at the distal end of the susceptor 136.

As may be appreciated, as a result of the limit position being located distally of the distal end of the susceptor 136, there is a portion of the length of the aerosol-generating material 1105 within the smoking article that, when the article 110 is fully inserted in the device, does not overlap with any heating element. This portion extends proximally by a first distance 151 from the distal end 1101 of the aerosol-generating material 1105. The inventors consider that this portion, which is heated to a significantly lesser degree than other parts of the aerosol-generating material 1105, may act to collect and/or absorb condensation, which might otherwise build up within the device, for instance within inlet or outlet conduits.

In the particular example shown in FIG. 7a, the stop 105 comprises an annular surface. However, it could instead comprise an array of circumferentially spaced protrusions, or any suitable structure.

In many cases, stop 105 will be aligned with the opening 104 in the device 100 through which article 110 is inserted (and also with the article receiving chamber 101). Furthermore, the stop 105 may have a minimum internal diameter that is smaller (for example by 2 mm or more) than a minimum internal diameter of the opening 104, so that, while the article may move freely through the opening 104, its movement is blocked by stop 105.

It may also be noted that in the particular embodiment shown in FIG. 7a, the distal end of the susceptor 136 is flared outwardly. In some embodiments, this flared distal end may have an extent of 2 mm or less in the length direction of the susceptor. A flared distal end may assist in reliably positioning the susceptor 136 during assembly of the device. For example, as shown in FIG. 7a, the flared distal end may engage with (or abut with) an abutment 1315. In the particular example shown in FIG. 7a, the abutment 1315 comprises an annular surface. However, it could instead comprise an array of circumferentially spaced protrusions, or any suitable structure.

In the particular example shown in FIG. 7a, abutment 1315 is provided by component 1038, which defines inlet conduit 103a (at least in part). Thus, in the example shown in FIG. 7a, component 1038 provides both stop 105 and abutment 1315. Nonetheless, this is merely an illustrative arrangement and abutment 1315 could be provided by any suitable component of the device 1.

As may be seen from FIG. 7a, the device 100″″ includes an article-receiving or heating chamber 1010 and an inlet conduit 103a. As is apparent, the width of the inlet conduit 103a is smaller than the width of the article-receiving chamber 1010; this may, for example, provide the user with a desirable amount of draw or impedance to flow.

As may also be seen from FIG. 7a, a distal portion 1015 of the article-receiving chamber 1010, which extends from the distal end of susceptor 136 (or, more generally, from the distal end of the distalmost heating element, where the device 100″″ has several heating elements) has a width that is greater than or equal to a portion of the article-receiving chamber 1010 that is located proximally. Such an arrangement may assist the insertion of the article into the distal portion 1015 of the article-receiving chamber.

As shown in FIG. 7a, the distal portion 1015 of the article-receiving chamber 1010 may be separated from inlet conduit 103a by stop 105. In the particular example shown, stop 105 is provided at the juncture of the distal portion 1015 of article-receiving chamber 1010 and inlet conduit 103a.

In some embodiments, the distal portion 1015 of the article-receiving chamber 1010 may be defined by thermally insulating material. This may further assist in reducing the amount of heat applied to the distal portion of the smoking article. Suitably, the thermally insulating material may be a plastic, for example polyether ether ketone.

It should be understood that, while a susceptor 136 is employed as a heating element in the device 100″″ of FIG. 7a, the present aspect is not so limited. Indeed, it is considered that various different types of heating element might be utilised, depending on the particular application. For example, susceptor 136 might be replaced by a resistive heating element, such as a resistive wire coil, or one or more interconnected conductive tracks provided on a substrate (e.g. forming part of a film heater).

Furthermore, the inventors envisage that it may be appropriate to additionally (or alternatively) provide an unheated portion at the proximal end 1102 of the aerosol-generating material 1105 within the smoking article 110.

To illustrate the broad scope of this aspect of the disclosure, reference is directed to FIG. 7b, which is a schematic diagram showing a smoking article 110 fully inserted into a device according to a further embodiment of this aspect of the disclosure. For ease of explanation, the device shown in FIG. 7b includes only a single heating element 1200, which is shown schematically; however, it will be understood that the device could include two, three or more heating elements, depending on the particular application.

As is apparent, FIG. 7b shows the article 110 fully inserted into the device, with the distal end 111 of the article 110 at the limit position defined by stop 105.

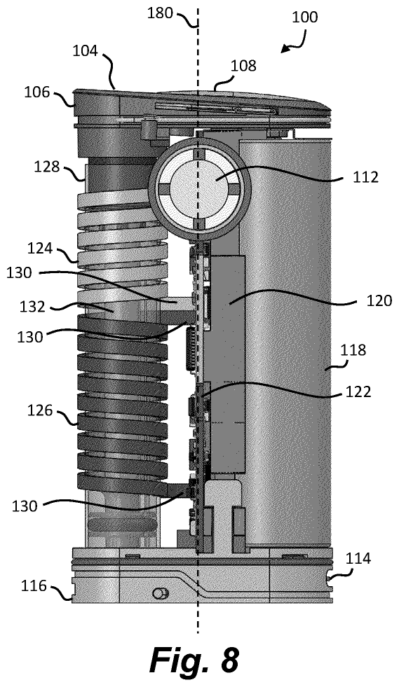

FIG. 7b further shows the aerosol-generating material 1105 within the article 110. The length of the aerosol-generating material 1105 is indicated in FIG. 8 by double-headed arrow 1005.

As illustrated in FIG. 7b, in some embodiments, the distal end 111 of the article 110 may be defined by the distal end 1101 of the aerosol-generating material 1105. As also illustrated in FIG. 7b, the aerosol-generating material 1105 may be in the form of an elongate body, for example a cylindrical body. It may be further noted that, in the particular example shown in FIG. 7b, the article 110 includes a filter 1106, which extends from the proximal end 1102 of the aerosol-generating material 1105.

As shown in FIG. 7b, when the article 110 is in the fully inserted position, there is a first portion of the length of the aerosol-generating material 1105, which extends a first distance 1001 proximally from the distal end 1101 of the aerosol-generating material 1105, that does not overlap with any heating element.

As also shown in FIG. 7b, there is, in addition, a second portion of the length of the aerosol-generating material 1105, which extends a second distance 1002 distally from the proximal end 1102 of the aerosol-generating material 1105, that likewise does not overlap with any heating element.

The first and second portions of the article may each act to collect and/or absorb condensation, which might otherwise build up within the device, for instance within inlet or outlet conduits.

The first distance 1001 may, for example, be greater than or equal to 2 mm and less than or equal to 10 mm. In certain cases it may be greater than or equal to 3 mm and less than or equal to 7 mm. In other cases it may be about 5 mm. Likewise, the second distance 1002 may, for example, be greater than or equal to 2 mm and less than or equal to 10 mm. In certain cases, it may be greater than or equal to 3 mm and less than or equal to 7 mm. In other cases it may be about 5 mm. In some cases, the first and second distances 1001, 1002 may be substantially equal.

Although FIG. 7b shows a device where neither the first portion 1001 nor the second portion 1002 of the length of the aerosol-generating material 1105 overlaps with any heating element, it should be understood that, in other embodiments, the device may be configured such that only the second portion of the length of the aerosol-generating material 1105 does not overlap with any heating element. (Such embodiments will therefore have at least one heating element that overlaps with the proximal end of the aerosol-generating material 1105.)

Reference is next directed to FIGS. 8-11B, which illustrate various features of the construction and operation of the devices of FIGS. 1-3. Similar features may also be employed in the devices of FIGS. 5a-7b.

Turning first to FIG. 8, as shown, the device 100 may comprise a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

FIG. 8 depicts the device 100 of FIG. 1 with the outer cover 102 removed and without an article 110 present. The device 100 defines a longitudinal axis 180.

As shown in FIG. 8, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 may further comprise a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device may further comprise at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

As noted above, in the example device 100, the heating assembly is an inductive heating assembly and comprises various components to heat the aerosol generating material 110a via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section 134 of the susceptor 132 and the second inductor coil 126 is configured to generate a second varying magnetic field for heating a second section 136 of the susceptor 132. Thus, as discussed above with reference to FIG. 2, first inductor coil 124 and first section 134 of susceptor 132 may be considered part of a first heating unit 161, in which first section 134 of susceptor 132 acts as a heating element, generating heat that is transferred to the aerosol-generating material. By contrast, second inductor coil 126 and second section 136 of susceptor 132 may be considered part of a second heating unit 162, in which second section 136 of susceptor 132 acts as a heating element, generating heat that is transferred to the aerosol-generating material.

In the example shown in FIG. 8, the first inductor coil 124 is adjacent to the second inductor coil 126 in a direction along the longitudinal axis 180 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

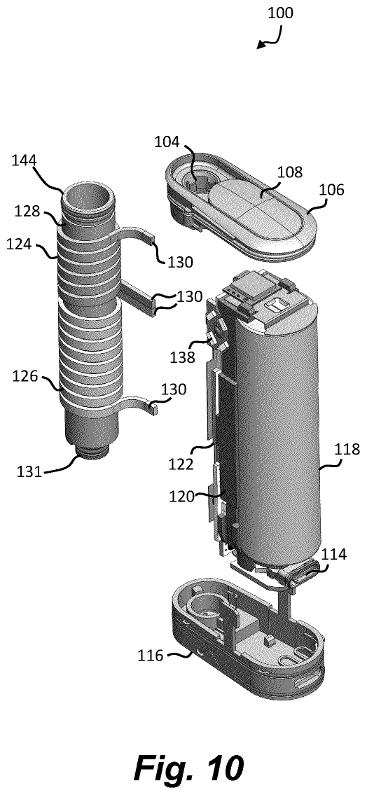

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 10, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section/portion of the article 110, and at a later time, the second inductor coil 126 may be operating to heat a second section/portion of the article 110. Winding the coils in opposite directions helps reduce the current induced in the inactive coil when used in conjunction with a particular type of control circuit. In FIG. 8, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a heating chamber 101 within which aerosol generating material is received. For example, the article 110 can be inserted into the susceptor 132. In this example the susceptor 120 is tubular, with a circular cross section.

The susceptor 132 may be made from one or more materials. In one example, the susceptor 132 comprises carbon steel having a coating of Nickel or Cobalt.

In some examples, the susceptor 132 may comprise at least two materials capable of being heated at two different frequencies for selective aerosolization of the at least two materials. For example, a first section of the susceptor 132 (which is heated by the first inductor coil 124) may comprise a first material, and a second section of the susceptor 132 which is heated by the second inductor coil 126 may comprise a second, different material. In another example, the first section may comprise first and second materials, where the first and second materials can be heated differently based upon operation of the first inductor coil 124. The first and second materials may be adjacent along an axis defined by the susceptor 132, or may form different layers within the susceptor 132. Similarly, the second section may comprise third and fourth materials, where the third and fourth materials can be heated differently based upon operation of the second inductor coil 126. The third and fourth materials may be adjacent along an axis defined by the susceptor 132, or may form different layers within the susceptor 132. Third material may the same as the first material, and the fourth material may be the same as the second material, for example. Alternatively, each of the materials may be different. The susceptor may comprise carbon steel or aluminium for example.

The device 100 of FIG. 8 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 8, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

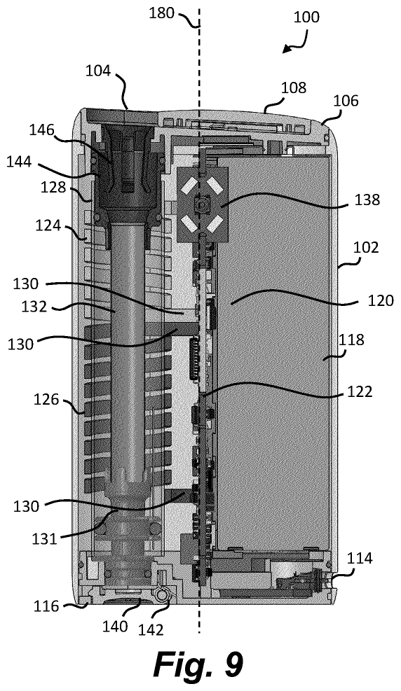

FIG. 9 shows a side view of device 100 in partial cross-section. The outer cover 102 is present in this example. The rectangular cross-sectional shape of the first and second inductor coils 124, 126 is more clearly visible.

The device 100 further comprises inlet conduit support 131 which, in the particular example illustrated, engages one end of the susceptor tube 132 to hold the susceptor tube 132 in place. The inlet conduit support 131 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor tube 132. A user may open the second lid 140 to clean the susceptor tube 132 and/or the interior surface of inlet conduit 103a.

The device 100 further comprises an expansion chamber 144 which extends away from a proximal end of the susceptor 132 towards the opening 104 of the device. As noted above, expansion chamber 144 forms part of the outlet conduit 103b in the example device 1 shown in FIGS. 1 and 2. Located at least partially within the expansion chamber 144 is a retention clip 146 to abut and hold the article 110 when received within the device 100. The expansion chamber 144 is connected to the end member 106.

FIG. 10 is an exploded view of the device 100 of FIG. 1, with the outer cover 102 omitted.

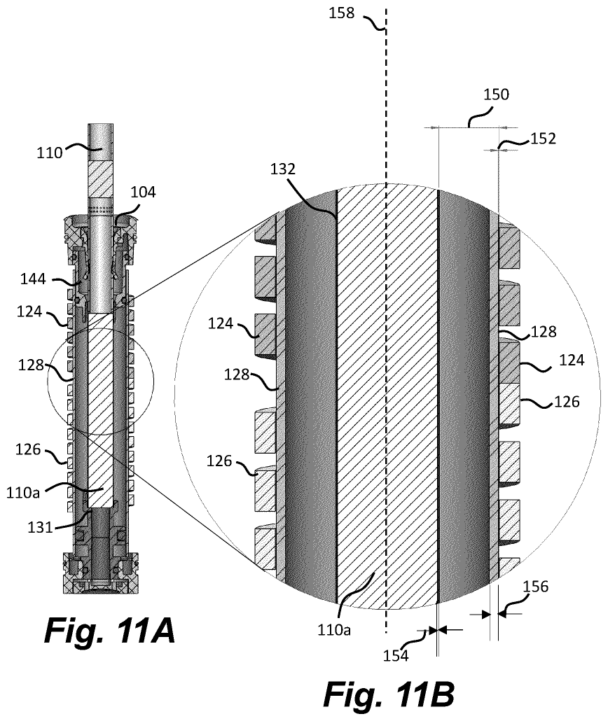

FIG. 11A depicts a cross-section of a portion of the device 100 of FIG. 8. FIG. 11B depicts a close-up of a region of FIG. 11A. FIGS. 11A and 11B show the article 110 received within the susceptor 132, where the article 110 is dimensioned so that the outer surface of the article 110 abuts the inner surface of the susceptor 132. This ensures that the heating is most efficient. The article 110 of this example comprises aerosol-generating material 110a. The aerosol-generating material 110a is positioned within the susceptor 132. The article 110 may also comprise other components such as a filter, wrapping materials and/or a cooling structure.

FIG. 11B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3-3.5 mm, or about 3.25 mm.

FIG. 11B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

Although the devices illustrated in FIGS. 1-11B have heating elements for the aerosol-generating material that surround the heating chamber, it should be understood that other devices embodying the various aspects disclosed herein could have at least one heating element (shaped, for example, like a pin, rod or blade) that projects into the heating chamber so as to heat the aerosol-generating material from the inside outwards. The at least one heating element may, for example, be aligned with a longitudinal axis of the heating chamber.

“Session of use” as used herein refers to a single period of use of the aerosol provision device by a user. The session of use begins at the point at which power is first supplied to at least one heating unit present in the heating assembly. The device will be ready for use after a period of time has elapsed from the start of the session of use. The session of use ends at the point at which no power is supplied to any of the heating elements in the aerosol provision device. The end of the session of use may coincide with the point at which the smoking article is depleted (the point at which the total particulate matter yield (mg) in each puff would be deemed unacceptably low by a user). The session will have a duration of a plurality of puffs. Said session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may be initiated by the user actuating a button or switch on the device, causing at least one heating element to begin rising in temperature.

A “heating chamber” as used herein may for example refer to a space that is heating by at least one heating element of at least one heating unit. In some examples, the heating chamber may have two open ends (e.g. open proximal and distal ends) and there may, for instance, be an abrupt change in cross-sectional area at one or both of these open ends. In some examples, a proximal end of the inlet conduit may open into, or connect directly to, a distal end of the heating chamber. There may thus be an abrupt change in cross-sectional area between the proximal end of the inlet conduit and the distal end of the heating chamber. Hence (or otherwise), the cross-sectional area of the proximal end of the inlet conduit may be smaller than the cross-sectional area of the distal end of the heating chamber.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device for generating aerosol from aerosol-generating material, the aerosol provision device comprising:
a heating chamber for receiving the aerosol-generating material;
an inductive heating unit for heating the aerosol-generating material during a session of use; and
a conduit having an interior surface, the conduit fluidically connecting the heating chamber with the exterior of the aerosol provision device;
wherein the aerosol provision device is configured so that at least a portion of the interior surface of the conduit is heated during a session of use to thereby substantially prevent accumulation of condensation within the conduit.

2. An aerosol provision device for generating aerosol from aerosol-generating material, the aerosol provision device comprising:
a heating chamber for receiving the aerosol-generating material;
an inductive heating unit for heating the aerosol-generating material during a session of use, when the aerosol-generating material is located in the heating chamber; and
a conduit having an interior surface, the conduit fluidically connecting the heating chamber with the exterior of the aerosol provision device;
wherein the aerosol provision device is configured so the interior surface of the conduit is heated during the session of use, so that the at least a portion of the interior surface attains a temperature greater than or equal to 85° C.

3. The device of any one of claim 1 or claim 2, wherein at least a portion of the interior surface is formed of thermally conductive material having a thermal conductivity greater than 1 W/m/K.

4. An aerosol provision device for generating aerosol from aerosol-generating material, the aerosol provision device comprising:
a heating chamber for receiving the aerosol-generating material;
a heating unit for heating the aerosol-generating material during a session of use; and
a conduit having an interior surface, the conduit fluidically connecting the heating chamber with the exterior of the aerosol provision device;
wherein at least a portion of the interior surface is formed of thermally conductive material having a thermal conductivity greater than 1 W/m/K.

5. The device of claim 4, wherein the heating unit is an inductive heating unit.

6. The device of any one of claims 3-5, wherein the thermally conductive material has a thermal conductivity greater than 10 W/m/K, optionally greater than 20 W/m/K, and further optionally greater than 50 W/m/K.

7. The device of any one of claims 3-6, wherein the conduit has a first end and a second end, the first end being nearer to the heating chamber than the second end;
wherein the at least a portion of the interior surface formed of thermally conductive material has a first end and a second end, the first end being nearer to the heating chamber than the second end;
wherein the second end of the at least a portion of the interior surface formed of thermally conductive material is nearer to the heating chamber than the second end of the conduit and/or the first end of the at least a portion of the interior surface formed of thermally conductive material is located at the first end of the conduit.

8. The device of any one of claims 3-7, further comprising a conduit support having an interior surface defining a passageway; wherein the at least a portion of the interior surface of the conduit formed of thermally conductive material is provided by a layer of thermally conductive material on the interior surface of the conduit support.

9. The device of any one of claims 3-7, further comprising a tubular component constructed of thermally conductive material, the at least a portion of the interior surface formed of thermally conductive material being provided by the tubular component;
optionally wherein the tubular component provides the entirety of the interior surface of the conduit.

10. The device of any one of claims 3-9, wherein the thermally conductive material is a ceramic material, such as alumina or zirconia, or a metallic material, such as aluminum, brass or stainless steel.

11. The device of any one of claims 3-10, wherein the thermally conductive material is an electrically conductive material.

12. The device of any one of claims 3-11, wherein the thermally conductive material is a ferromagnetic and/or a ferrimagnetic material

13. The device of any one of claims 1-12, wherein the heating of the interior surface of the conduit during a session of use results, at least in part, from conduction of heat generated by the heating unit.

14. The device of any one of claims 1-13, wherein the aerosol provision device is configured so the conduit is heated during the session of use and thereby at least a portion of the interior surface attains a temperature greater than or equal to 85° C., optionally greater than or equal to 90° C., further optionally greater than or equal to 95° C., and further optionally greater than or equal to 100° C.

15. The device of any one of claims 1-14, wherein the aerosol provision device is configured so the interior surface of the conduit is heated during the session of use and thereby at least a middle portion of the interior surface, which is mid-way between a first end and a second end of the conduit, attains a temperature greater than or equal to 70° C., optionally 80° C., further optionally 90° C., and still further optionally 100° C.

16. The device of any one of claims 1-15, wherein the heating of the interior surface of the conduit causes air within the conduit to be heated to a temperature greater than or equal to 120° C., optionally greater than or equal to 150° C., further optionally greater than or equal to 170° C., and still further optionally greater than or equal to 200° C.

17. An aerosol provision device for generating aerosol from aerosol-generating material, the aerosol provision device comprising:
a heating chamber for receiving the aerosol-generating material;
a heating unit for heating the aerosol-generating material during a session of use;
a conduit fluidically connecting the heating chamber with the exterior of the aerosol provision device; and
an air heating unit for heating air within the conduit to thereby substantially prevent accumulation of condensation within the conduit.

18. The device according to claim 17, wherein the air heating unit comprises one or more heating elements.

19. The device according to claim 17 or claim 18, wherein each of the one or more heating elements of the air heating unit is spaced from the exterior of the device.

20. The device according to any one of claims 17-19, wherein at least some of, and optionally all of, the one or more heating elements are resistive heating elements.

21. The device according to any one of claims 17-20, further comprising at least one aerosol-generating material sensor arranged to sense whether aerosol-generating material is present within the heating chamber,
wherein the device is configured so that the air heating unit is controlled in dependence on an output signal from the at least one aerosol-generating material sensor.

22. The device according to claim 21, wherein the air heating unit is configured to heat the air within the conduit to above a threshold temperature in response to the output signal from the at least one aerosol-generating material sensor indicating that aerosol-generating material has been removed from the heating chamber.

23. The device according to any one of claims 17-22, further comprising at least one inhalation sensor arranged to sense whether a user is inhaling aerosol generated by the device,
wherein the device is configured so that the air heating unit is controlled in dependence on an output signal from the at least one inhalation sensor.

24. The device according to claim 23, wherein the air heating unit is configured to heat the air within the conduit to above a threshold temperature in response to the output signal from the at least one inhalation sensor indicating that the user has inhaled aerosol generated by the device.

25. The device according to claim 22 or claim 24, wherein the threshold temperature is greater than or equal to 120° C., optionally greater than or equal to 150° C., further optionally greater than or equal to 170° C., further optionally greater than or equal to 200° C.

26. The device according to any one of claims 17-19, 21 and 23, wherein the air heating unit is configured to heat the air within the conduit to above a threshold temperature that is greater than or equal to 120° C., optionally greater than or equal to 150° C., further optionally greater than or equal to 170° C., further optionally greater than or equal to 200° C.

27. An aerosol provision device for generating aerosol from aerosol-generating material, the aerosol provision device comprising:
a heating assembly comprising an inductor;
a heating chamber for receiving the aerosol-generating material and within which the aerosol-generating material is heatable by the heating assembly; and
a conduit fluidically connecting the heating chamber with an opening at an exterior of the aerosol provision device, wherein at least a portion of the conduit is defined by a component comprising a first susceptor;
wherein the device is configured such that the first susceptor is heatable by the inductor to heat the conduit, thereby to substantially prevent accumulation of condensation within the conduit.

28. The device according to claim 27, wherein the first susceptor surrounds at least part of the conduit.

29. The device according to claim 27 or claim 28, wherein the heating assembly is configured such that the aerosol-generating material, when present in the heating chamber, is heatable by the inductor.

30. The device according to claim 29, wherein the heating assembly comprises a second susceptor that is heatable by the inductor to thereby heat the heating chamber.

31. The device according to claim 30, wherein the second susceptor surrounds at least part of the heating chamber.

32. The device according to claim30 or claim 31, wherein the first susceptor abuts the second susceptor so as to be heatable by thermal conduction from the second susceptor.

33. The device according to any one of claims 27-32, wherein the conduit has a larger or smaller width than the heating chamber.

34. The device according to any one of claims 27-33, wherein the inductor comprises a coil, wherein at least part of the inductor coil surrounds at least part of the first susceptor.

35. The device according to any one of claims 27-34, further comprising a support comprising thermally insulating material, and having first and second ends, the first end being nearer to the heating chamber than the second end, and a passageway extending between the first and second ends; wherein at least a portion of the first susceptor is located within the passageway.

36. The device according to claim 35, wherein the first susceptor is spaced from the second end of the support, so as to be spaced from the opening.

37. An aerosol provision device for generating aerosol from aerosol-generating material, the aerosol provision device comprising:
a heating assembly comprising a heating element that is heatable by the heating assembly;
a heating chamber for receiving the aerosol-generating material and within which the aerosol-generating material is heatable by the heating element; and
a conduit fluidically connecting the heating chamber with an opening at an exterior of the aerosol provision device, wherein at least a portion of the conduit is defined by a component comprising thermally conductive material;
wherein the thermally conductive material of the component abuts the heating element so as to be heatable by thermal conduction from the heating element to heat the conduit, thereby to substantially prevent accumulation of condensation within the conduit.

38. The device according to claim 37, wherein the thermally conductive material surrounds at least part of the conduit.

39. The device according to claim 37 or claim 38, wherein a proximal end of the component circumferentially surrounds a distal end of the heating element.

40. The device according to any one of claims 37-39, wherein the heating assembly comprises an inductive heating unit and the heating element is a susceptor.

41. The device according to any one of claims 37-40, wherein the heating element surrounds at least part of the heating chamber.

42. The device according to any one of claims 37-41, wherein the conduit has a larger or smaller width than the heating chamber.

43. The device according to any one of claims 37-42, further comprising a support comprising thermally insulating material, and having first and second ends, the first end being nearer to the heating chamber than the second end, and a passageway extending between the first and second ends; wherein at least a portion of the component is located within the passageway.

44. The device according to claim 43, wherein the component is spaced from the second end of the support, so as to be spaced from the opening.

45. The device of any one of claims 1-44, wherein the conduit is an inlet conduit.

46. The device of any one of claims 1-44, wherein the conduit is an outlet conduit.

47. An aerosol provision device for receiving an article comprising aerosol-generating material and for generating aerosol from the aerosol-generating material, the aerosol provision device comprising:
a stop, which prevents a distal end of the article from moving distally beyond a limit position when the article is inserted in the aerosol provision device; and
a heating assembly for heating the aerosol-generating material during a session of use, the heating assembly comprising a heating element, within which heat is generated during use of the heating assembly;
wherein, when the article is fully inserted into the device with the distal end of the article located at the limit position, there is a first portion of a length of the aerosol-generating material that does not overlap with any heating element that is heatable to heat the article, the first portion extending either a first distance proximally from the distal end of the aerosol-generating material, or a first distance distally from a proximal end of the aerosol-generating material.

48. A device according to claim 47, wherein the heating unit is an inductive heating unit, and the heating element is a susceptor.

49. A device according to claim 47 or claim 48, wherein the heating element has a distal end that is outwardly flared.

50. A device according to any one of claims 47-49, further comprising a heating chamber; wherein the heating element surrounds a part of the heating chamber.

51. A device according to claim 50, further comprising an inlet conduit, the inlet conduit fluidically connecting the heating chamber with an opening at an exterior of the aerosol provision device; wherein a width of the heating chamber is greater than a width of the inlet conduit.

52. A device according to claim 50 or 51, wherein the heating chamber has a distal portion, which extends from a distal end of the heating element to the stop, the distal portion having a width that is equal to or greater than a width of a portion of the heating chamber located proximally of the distal portion.

53. A device according to claim 52, wherein the distal portion of the heating chamber is defined by thermally insulating material.

54. A device according to claim 53, wherein the thermally insulating material is a plastic and optionally is polyether ether ketone.

55. An aerosol provision device for generating aerosol from aerosol-generating material, the aerosol provision device comprising:
a heating assembly; and
one or more components that define:
a heating chamber for receiving the aerosol-generating material and within which the aerosol-generating material is heatable by the heating assembly; and
a conduit fluidically connecting the heating chamber with an exterior of the aerosol provision device;
wherein the one or more components provide a hermetic seal where the heating chamber and the conduit meet.

56. The device according to claim 55, wherein the one or more components comprise at least one conduit-defining component, which defines the conduit, and at least one heating chamber-defining component, which defines the heating chamber, and wherein the at least one conduit-defining component is sealingly joined to the at least one heating chamber-defining component.

57. The device according to claim 56, wherein the at least one conduit-defining component is sealingly joined to the at least one heating chamber-defining component by a weld or a braze.

58. The device according to claim 57, wherein the weld or braze is about an exterior of the at least one conduit defining component and the heating chamber-defining component.

59. The device according to any one of claims 56 to 58, wherein at least one of the at least one conduit-defining component comprises thermally-conductive material.

60. The device according to claim 55, wherein the one or more components consist of a single integrally-formed component.

61. The device according to any one of claims 55 to 60, wherein the heating assembly is an inductive heating assembly and comprises at least one inductor, and the one or more components provide a first susceptor, which is heatable by the at least one inductor to thereby heat the aerosol-generating material so as to generate the aerosol.

62. The device according to any one of claims 56 to 59, and claim 61, wherein the at least one heating chamber-defining component comprises the first susceptor.

63. The device according to claim 62, wherein the at least one conduit-defining component comprises a second susceptor that is heatable by the at least one inductor.

64. The device according to claim 63, wherein the at least one inductor comprises a first inductor and a second inductor,
wherein the first susceptor is heatable by the first inductor.
wherein the second susceptor is heatable by the second inductor.

65. The device according to claim 60 and claim 61, wherein the at least one inductor comprises a first inductor and a second inductor,
wherein the first inductor is operable to inductively heat a first portion of the integrally-formed component, the first portion defining the heating chamber and providing said first susceptor, and
wherein the second inductor is operable to inductively heat a second portion of the integrally-formed component, the second portion defining the conduit.

66. The device according to any one of claims 55 to 65, wherein the conduit fluidically connects a first end of the heating chamber with a first opening at the exterior of the aerosol provision device,
wherein the one or more components further define an additional conduit that fluidically connects a second, opposite end of the heating chamber with a second opening at the exterior of the aerosol provision device, and
wherein the one or more components additionally provide a hermetic seal where the heating chamber and the additional conduit meet.

67. The device according to claim 66, wherein the conduit that fluidically connects the first end of the heating chamber with the first opening has a smaller internal width than the heating chamber.

68. The device according to claim 66 or claim 67, wherein the additional conduit has a larger internal width than the heating chamber.

69. A method of generating an aerosol comprising using an aerosol provision device according to any of claims 1-68 to heat aerosol-generating material so as to generate the aerosol.

70. An aerosol-generating system comprising:
the aerosol provision device of any one of claims 1-68; and
the aerosol-generating material.
